(19) United States
(12) Patent Application Publication
(10) Pub. No.: US 2010/0296822 A1
(43) Pub. Date: Nov. 25, 2010

(54) IMAGE FORMING APPARATUS

(75) Inventor: Kazumasa TAKADA, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/752,898

(22) Filed: Apr. 1, 2010

Related U.S. Application Data
(60) Provisional application No. 61/167,076, filed on Apr. 6, 2009.
(60) Provisional application No. 61/167,806, filed on Apr. 8, 2009.

(51) Int. Cl. G03G 15/00

(52) U.S. Cl. 399/9; 399/74; 399/301

(57) ABSTRACT

Failures of respective light emitting elements are detected without printing on a sheet. An image forming apparatus includes an optical scanning section including plural light emitting sections each including plural light emitting elements, plural photoreceptors which are provided correspondingly to the respective light emitting sections and on which electrostatic latent images are formed by emitted lights of the respective light emitting sections, developing sections to develop the respective electrostatic latent images formed on the respective photoreceptors with toners of different colors, a transfer target section to which respective images developed by the developing sections are transferred, a density detection section to detect densities of the respective images transferred to the transfer target section, and a failure determination section, in which when registration control is performed based on respective first test images transferred from the respective photoreceptors, the density detection section detects a density of a second test image formed on the transfer target section by causing a light emitting element included in a first light emitting section among the plural light emitting sections to emit light, and the failure determination section determines a failure of the light emitting element based on a detection result.

### CROSS-REFERENCE TO RELATED APPLICATION

This application is based upon and claims the benefit of priority from: U.S. provisional application 61/167,076, filed on Apr. 6, 2009; and U.S. provisional application 61/167,806, filed on Apr. 8, 2009, the entire contents of each of which are incorporated herein by reference.

### TECHNICAL FIELD

The specification relates to an image forming apparatus including an optical scanning section having plural light emitting sections each having plural light emitting elements.

### BACKGROUND

Hitherto, in a color image forming apparatus of four colors of Y, M, C and K, when a reference color of a main scanning reference position signal BD is made, for example, Y, laser control of the other colors is performed based on the BD signal for Y color. Such an image forming apparatus is a middle speed machine up to about 45 PPM, and one laser (single beam) is provided for each color. When an attempt is made to realize a higher speed color image forming apparatus by using one laser for one color, the realization is usually difficult due to the upper limit limitation of polygon rotation speed. Thus, the realization is achieved by using plural lasers for one color. Besides, when a higher quality image is formed, the realization is achieved by increasing the number of lasers and reducing the interval between lasers, and for example, a 600 dpi single laser is replaced by a 1200 dpi 2LD array.

However, in the above structure, although the failure of the BD signal laser of the reference color Y can be detected by the presence or absence of the BD signal, the failure of other lasers (a laser which is for the reference color Y and is not used for the BD signal, and lasers for the other colors) can not be detected, and therefore, another detection unit is required. For example, a method is used in which determination is made by using an image printed on a sheet. However, in the related art method, since factors other than the laser, such as abnormality of a high voltage system or a mechanical position shift, are included, there is a problem that it is difficult to determine whether the failure is due to non-emission of the laser. Thus, a unit is required which can detect the failure of each of the lasers without including factors other than the laser.

### SUMMARY

In order to solve the problem, the specification discloses that an image forming apparatus includes an optical scanning section including plural light emitting sections each including plural light emitting elements, plural photoreceptors which are provided correspondingly to the respective light emitting sections and on which electrostatic latent images are formed by emitted lights of the respective light emitting sections, developing sections to develop the respective electrostatic latent images formed on the respective photoreceptors with toners of different colors, a transfer target section to which respective images developed by the developing sections are transferred, a density detection section to detect densities of the respective images transferred to the transfer target section, and a failure determination section, in which when registration control is performed based on respective first test images transferred from the respective photoreceptors, the density detection section detects a density of a second test image formed on the transfer target section by causing a light emitting element included in a first light emitting section among the plural light emitting sections to emit light, and the failure determination section determines a failure of the light emitting element based on a detection result.

The specification discloses that an image forming apparatus includes an optical scanning section including plural light emitting sections each including plural light emitting elements, plural photoreceptors which are provided correspondingly to the respective light emitting sections and on which electrostatic latent images are formed by emitted lights of the respective light emitting sections, developing sections to develop the respective electrostatic latent images formed on the respective photoreceptors with toners of different colors, a transfer target section to which respective images developed by the developing sections are transferred, a registration detection section to acquire information for registration control from the respective images transferred to the transfer target section, and a failure determination section, in which when image quality maintenance control is performed based on respective first test images transferred from the respective photoreceptors, the registration detection section detects a second test image formed on the transfer target section by causing a light emitting element of a first light emitting section among the plural light emitting sections to emit light, and the failure determination section determines a failure of the light emitting element based on a detection result.

The specification discloses that an image forming apparatus includes an optical scanning section including plural light emitting sections each including plural light emitting elements, a first sensor to acquire correction information for correcting a writing position in a main scanning direction by receiving emitted light from a first light emitting section among the plural light emitting sections, a second sensor which receives emitted light from a second light emitting section different from the first light emitting section among the plural light emitting sections and has a detection accuracy lower than that of the first sensor, and a failure determination section which determines a failure of the first light emitting section based on presence or absence of light reception in the first sensor when the respective light emitting elements included in the first light emitting section are made to emit light, and determines a failure of the second light emitting section based on presence or absence of light reception in the second sensor when the respective light emitting elements included in the second light emitting section are made to emit light.

The specification discloses that an image forming apparatus includes an optical scanning section including plural light emitting sections each including plural light emitting elements, a sensor to optically acquire correction information for correcting a writing position in a main scanning direction, and a failure determination section to determine failures of the respective light emitting sections based on presence or absence of light reception in the sensor when the respective light emitting elements included in the respective light emitting sections are made to emit light.

### DESCRIPTION OF THE DRAWINGS

FIG. 1 is a sectional view showing an internal structural example of a digital multi-function peripheral.

FIG. 2 is a block diagram schematically showing a structural example of a control system of the digital multi-function peripheral.

FIG. 3 is an arrangement view showing the arrangement of respective parts in an optical scanning section.

FIG. 4 is a view showing a structural example of an optical system in the optical scanning section.

FIG. 5 is a view for explaining scanning of a laser beam in the optical scanning section.

FIG. 6 is a view showing a structural example of an LD array.

FIG. 7 is a view showing a structural example of a laser control section.

FIG. 8 is a view in which operations and setting items in the laser control section shown in FIG. 7 are summarized.

FIG. 9 is a plan view of a transfer belt.

FIG. 10 is an explanatory view for explaining a detection method using a density sensor.

FIG. 11 is a plan view showing a test pattern for detecting a density of a toner image.

FIG. 12 is a schematic view showing a test pattern (first test image) for registration and a test pattern (second test image) for failure detection.

FIG. 13 is a flowchart showing a procedure of failure detection.

FIG. 14 is a schematic view showing a test pattern for image quality maintenance and a test pattern for failure detection.

FIG. 15 is a flowchart showing a method of failure detection.

FIG. 16 is a plan view of a transfer belt in which test patters are arranged in a main scanning direction.

FIG. 17 is a view for explaining scanning of a laser beam in an optical scanning section of embodiment 3.

FIG. 18 is a timing chart of embodiment 3.

FIG. 19 is another timing chart of embodiment 3.

FIG. 20 is another timing chart of embodiment 3.

FIG. 21 is a flowchart showing a method of failure detection of embodiment 3.

FIG. 22 is a view for explaining scanning of a laser beam in an optical scanning section of embodiment 4.

FIG. 23 is a flowchart showing a method of failure detection of embodiment 4.

FIG. 24 is a view for explaining scanning of a laser beam in an optical scanning section of embodiment 5.

FIG. 25 is a view for explaining scanning of a laser beam in an optical scanning section of embodiment 6.

### DETAILED DESCRIPTION

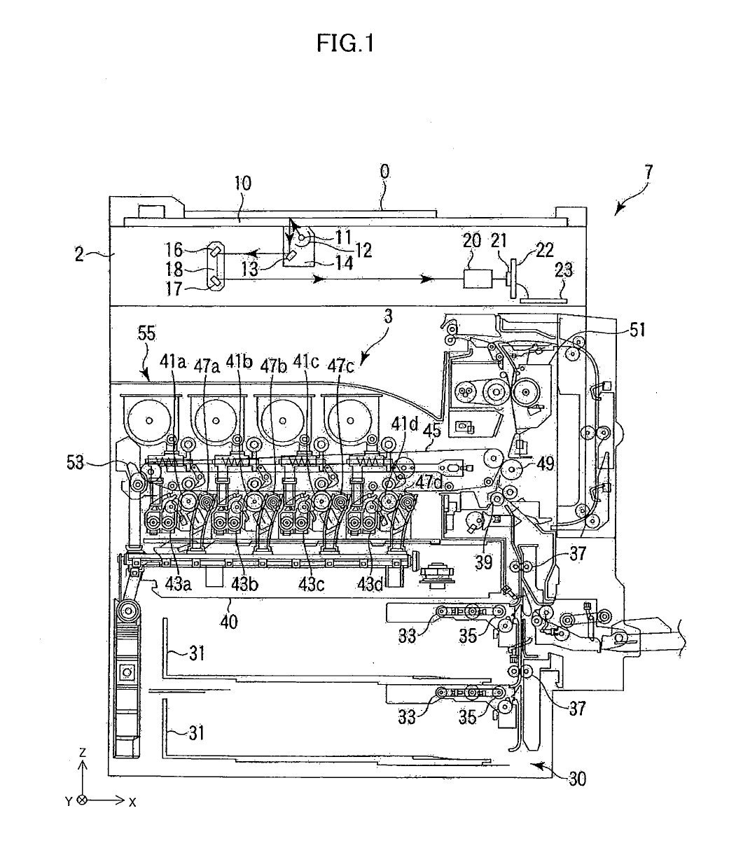

Hereinafter, embodiments of the invention will be described in detail with reference to the drawings. FIG. 1 is a sectional view showing an internal structural example of a color digital multi-function peripheral 1 which is an image forming apparatus of the invention.

The digital multi-function peripheral 1 shown in FIG. 1 includes a reading optical system 2 and an image forming section 3. The reading optical system 2 optically scans a document surface to read an image on a document as color image data (multi-value image data). The image forming section 3 forms an image based on the color image data (multi-value image data). Further, the digital multi-function peripheral 1 includes, as a unit configured to input and output image data, a facsimile interface (not shown) for transmitting and receiving facsimile data or a network interface (not shown) for performing network communication. By the structure as stated above, the digital multi-function peripheral 1 functions as a copier, a scanner, a printer, a facsimile or a network communication machine.

First, the structure of the reading optical system 2 will be described. As shown in FIG. 1, the reading optical system 2 includes a document table 10, a light source 10, a reflector 12, a first mirror 13, a first carriage 14, a second mirror 16, a third mirror 17, a second carriage 18, a condensing lens 20, a three-line CCD sensor 21, a CCD substrate 22 and a CCD control substrate 23.

A document O is placed on the document table 10. The document table 10 is made of, for example, glass. The light source 11 exposes the document O placed on the document table 10. The reflector 12 adjusts the distribution of light from the light source 11. The first mirror 13 guides light from the document surface to the second mirror 16. The first carriage 14 carries the light source 11, the reflector 12 and the first mirror 13. The first carriage 14 moves at a specified speed (V) in a sub-scanning direction of the document surface by driving force transmitted from a not-shown drive section.

The second mirror 16 and the third mirror 17 guide the light from the first mirror 13 to the condensing lens 20. The second carriage 18 carries the second mirror 16 and the third mirror 17. The second carriage 18 moves in the sub-scanning direction at a half speed (V/2) of the speed (V) of the first carriage 14. The second carriage 18 is driven at the speed of ½ of the first carriage, whereby the distance between the read position of the document surface and the light receiving surface of the three-line CCD sensor 21 is kept at a constant optical path length.

The light from the document surface is incident on the condensing lens 20 through the first, the second and the third mirrors 13, 16 and 17. The condensing lens 20 guides the incident light to the three-line CCD sensor 21 which converts it into electric signals. That is, the reflected light from the document surface passes through the glass of the document table 10, is successively reflected by the first mirror 13, the second mirror 16 and the third mirror 17, and forms an image on the light receiving surface of the three-line CCD sensor 21 through the condensing lens 20.

The three-line CCD sensor 21 includes a line sensor in which photoelectric conversion elements to convert light into electric signals are arranged in the main scanning direction. The three-line CCD sensor 21 converts the light from the document into electric signals of three-color image signals constituting a color image. For example, when a color image is read using three primary colors of light of R (red), G (green) and B (blue), the three-line CCD sensor 21 includes an R line sensor 21R to read a R (red) image, a G line sensor 21G to read a green image and a B line senor 21B to read a blue image.

The CCD substrate 22 includes a sensor drive circuit (not shown) to drive the three-line CCD sensor 21. The CCD control substrate 23 controls the CCD substrate 22 and the three-line CCD sensor 21. The CCD control substrate 23 includes a control circuit (not shown) to control the CCD substrate 22 and the three-line CCD sensor 21 and an image processing circuit (not shown) to process an image signal outputted from the three-line CCD sensor 21.

Next, the structure of the image forming section 3 will be described. As shown in FIG. 1, the image forming section 3 includes a sheet supply section 30, an optical scanning section 40, a first to a fourth photoconductive drums 41a to 41d, a first to a fourth developing devices 43a to 43d, a transfer belt 45, cleaners 47a to 47d, a transfer device 49, a fixing device 51, a belt cleaner 53 and a stock section 55.

The optical scanning section 40 emits laser beams (exposure lights) to form latent images on the first to the fourth photoconductive drums 41a to 41d. Here, the first to the fourth photoconductive drums 41a to 41d respectively correspond to three colors (Y, M, C) and black (K) forming the color image. The optical scanning section 40 irradiates the exposure lights corresponding to the respective color components of the image data to the respective photoconductive drums 41a to 41d as image carriers for the respective colors. The electrostatic latent images corresponding to the intensities of the laser beams (exposure lights) irradiated from the optical scanning section 40 are formed on the photoconductive drums 41a to 41d. The first to the fourth photoconductive drums 41a to 41d hold the formed electrostatic latent images as the images of the respective colors.

The first to the fourth developing devices 43a to 43d develop the latent images held by the respective photoconductive drums 41a to 41d with specific colors. That is, the developing devices 43a to 43d supply toners of the respective colors to the latent images held by the respective corresponding photoconductive drums 41a to 41d and develop the images. For example, it is assumed that the image forming section obtains a color image by the subtractive color mixture using three colors of yellow, magenta and cyan. In this case, the first to the fourth developing devices 43a to 43d visualize (develop) the latent images held by the photoconductive drums 41a to 41d with colors of yellow, magenta, cyan and black. That is, the first to the fourth developing devices 43a to 43d contain toners of colors of yellow, magenta, cyan and black. The colors contained in the first to the fourth developing devices 43a to 43d (order of development of the respective color images) is determined according to the image forming process or the toner characteristic. In this embodiment, the photoconductive drums 41a to 41d and the developing devices 43a to 43d correspond to yellow (Y), magenta (M), cyan (C) and black (K), respectively.

The transfer belt 45 functions as an intermediate transfer body. The toner images of the respective colors formed on the photoconductive drums 41a to 41d are sequentially transferred to the transfer belt 45 as the intermediate transfer body. For example, the toner images on the respective photoconductive drums 41a to 41d conveyed to the intermediate transfer position are respectively transferred onto the transfer belt 45 by intermediate transfer voltage. By this, a color toner image in which the images of the four colors (yellow, magenta, cyan and black) are superimposed is formed on the transfer belt 45. The transfer device 49 transfers the toner image formed on the transfer belt 45 to a sheet as an image formation target medium. A position shift sensor 26 and a density sensor 27 are provided downstream of the transfer belt 45 of the photoconductive drum 41d in the conveyance direction. The details of the position shift sensor 26 and the density sensor 27 will be described later.

The sheet supply section 30 supplies the sheet to which the toner image is transferred from the transfer belt 45 as the intermediate transfer body to the transfer device 49. The sheet supply section 30 supplies the sheet at suitable timing to the toner image transfer position of the transfer device 49. The sheet supply section 30 includes plural cassettes 31, pickup rollers 33, separation mechanisms 35, plural conveyance rollers 37 and an aligning roller 39.

The plural cassettes 31 contain sheets as image formation target media. The cassette 31 can contain a predetermined number of sheets of arbitrary sizes. The pickup roller 33 takes out the sheet one by one from the specified cassette 31. For example, as the cassette 31, a cassette directly indicated by the user is specified, or a cassette in which sheets of the optimum sheet size calculated based on document size, magnification and the like are contained is specified.

The separation mechanism 35 prevents two or more sheets from being taken out from the cassette by the pickup roller (sheets are separated into one sheet). The plural conveyance rollers 37 convey the sheet separated into one sheet by the separation mechanism 35 to the aligning roller 39. The aligning roller 39 conveys the sheet to the transfer position where the transfer device 49 contacts with the transfer belt 45 in accordance with the timing when the transfer device 49 transfers the toner image from the transfer belt 45 (the toner image is moved (at the transfer position)).

The fixing device 51 fixes the toner image to the sheet. For example, the fixing device 51 heats the sheet in a pressure state and fixes the toner image on the sheet. The fixing device 51 conveys the sheet subjected to the fixing process to the stock section 55. The stock section 55 is a paper discharge section to discharge the sheet subjected to the image formation process (image is printed). In the structural example shown in FIG. 1, the stock section 55 is provided in a space between the reading optical system 2 and the image forming section 3.

Besides, the belt cleaner 53 cleans the transfer belt 45. The belt cleaner 53 contacts with the transfer belt 45 at a specified position. The belt cleaner 53 removes waste toner remaining on the transfer surface of the transfer belt 45, to which the toner image is transferred, from the transfer belt 45.

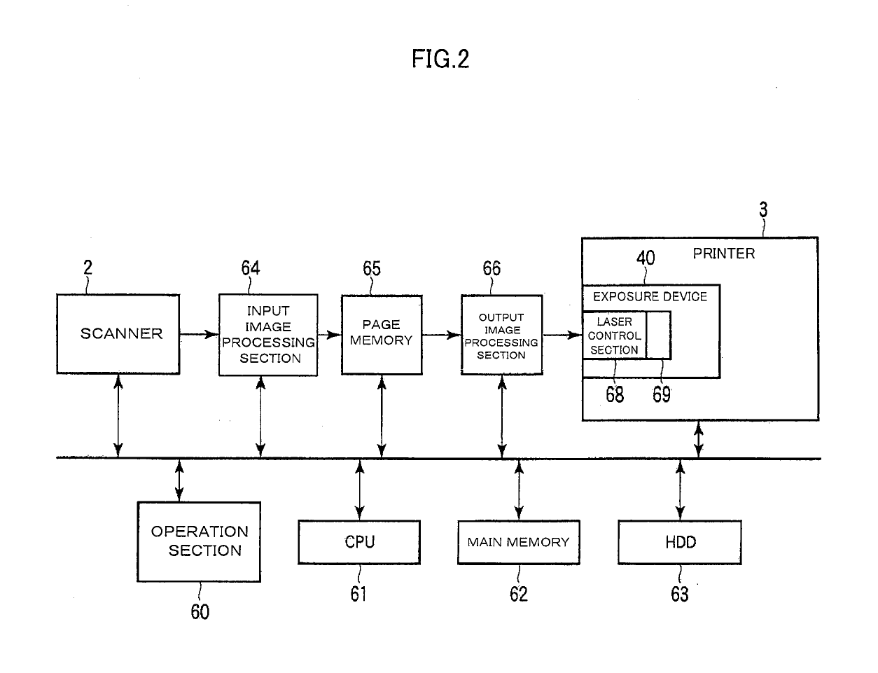

Next, the structure of the control system of the digital multi-function peripheral 1 will be described. FIG. 2 is a block diagram schematically showing a structural example of the control system in the digital multi-function peripheral 1. As shown in FIG. 2, the digital multi-function peripheral 1 includes, as the structure of the control system, an operation section 60, a CPU 61, a main memory 62, a HDD 63, an input image processing section 64, a page memory 65 and an output image processing section 66 in addition to the reading optical system 2 and the image forming section 3.

The operation section (control panel) 60 is used by the user to input operation instructions, or displays guidance to the user. The operation section 60 includes a display device and an operation key. For example, the operation section 60 includes a liquid crystal display device having a built-in touch panel and a hard key such as a numerical key pad.

The CPU 61 overall controls the whole digital multi-function peripheral 1. The CPU 61 executes programs stored in, for example, a not-shown program memory and realizes various functions. The main memory 62 is a memory in which work data and the like are stored. The CPU 61 uses the main memory 62 to execute various programs and realizes various processes. For example, the CPU 61 controls the scanner 2 and the printer 3 in accordance with a program for copy control, and realizes copy control. That is, the digital multi-function peripheral 1 functions as a copier when the CPU 61 execute the program for copy control.

The HDD (Hard Disk Drive) 63 is a nonvolatile large-capacity memory. For example, the HDD 63 stores image data. Besides, the HDD 63 stores set values (default set values) in various processes. Further, the HDD 63 may store programs executed by the CPU 61.

The input image processing section 64 processes an input image. The input image processing section 64 functions as, for example, a scanner type image processing section to process an image read by the scanner 2 as an input image. In this case, the input image processing section 64 performs a shading correction process, a gradation conversion process, an inter-line correction process, a variable power process, a compression process and the like on the image data read by the scanner 2. Incidentally, the input image processing section 64 may process an image inputted through a not-shown facsimile interface or a network interface.

For example, the shading correction process is the process of correcting image data according to the sensitivity variation of respective photoelectric conversion elements in the CCD or the light distribution characteristic of a lamp (not shown) for illuminating a document. The gradation conversion process is the process of converting values (for example, respective signal values of R, G, B) of respective pixels constituting the image data in accordance with a not-shown lookup table (LUT). The inter-line correction process is the process of correcting the physical position shift of the respective sensors of RGB in the CCD line sensor of the scanner 2. The variable power process is for reducing or enlarging the image data to a desired size by image processing. The compression process is the process of quantizing the image data in order to compress the amount of data. The code data as the compressed image data (quantized image data) is stored in the page memory 65.

The page memory 65 is the memory to store the image data as a processing object. For example, the page memory 65 stores color image data of one page. The page memory 65 is controlled by a not-shown page memory control section. In the structural example shown in FIG. 2, the page memory 65 stores image data as a processing result processed by the input image processing section 64.

The output image processing section 66 processes the output image. In the structural example shown in FIG. 2, the output image processing section 66 functions as a printer system image processing section to generate image data printed on the sheet by the printer 3. The output image processing section 66 converts the image data stored in the page memory 65 into the image data for the printer.

For example, the output image processing section 66 performs various processes, such as an expansion process, a pixel conversion process, a filter process, an inking process, a gamma correction, and a gradation process, on the image data read from the page memory 65. The expansion process expands the quantized (coded) data (compressed image data) stored in the page memory 65. The pixel conversion process converts the color image including R, G and B signals read from the page memory 65 into color image data for printing including Y, M, C, K (Black) signals. The filter process is the process to correct the image data according to the kind of the image. The inking process is the process to detect an area of black characters or the like in which printing is performed only in black (K) in the image data. The gamma correction process is the process to correct the image data according to the gamma characteristic of the printer 3. The gradation process screens the image data subjected to the gamma correction.

Besides, the output image processing section 66 is connected to laser control sections 68 provided in the optical scanning section 40 in the printer 3. In the optical scanning section 40, the laser control sections 68 are connected to laser beam units 70 to emit laser beams. The laser control sections 68 are respectively formed on control substrates provided for the respective colors. The laser control sections 68 control the laser beams irradiated to the photoconductive drums 41a, 41b, 41c and 41d for the respective colors based on image signals of the respective colors supplied from the output image processing section 66. The laser beam units 70 emit the laser beams in accordance with the control of the laser control section 68. The structural example of the laser control sections 68 and the laser beam units 70 in the optical scanning section 40 will be described later in detail.

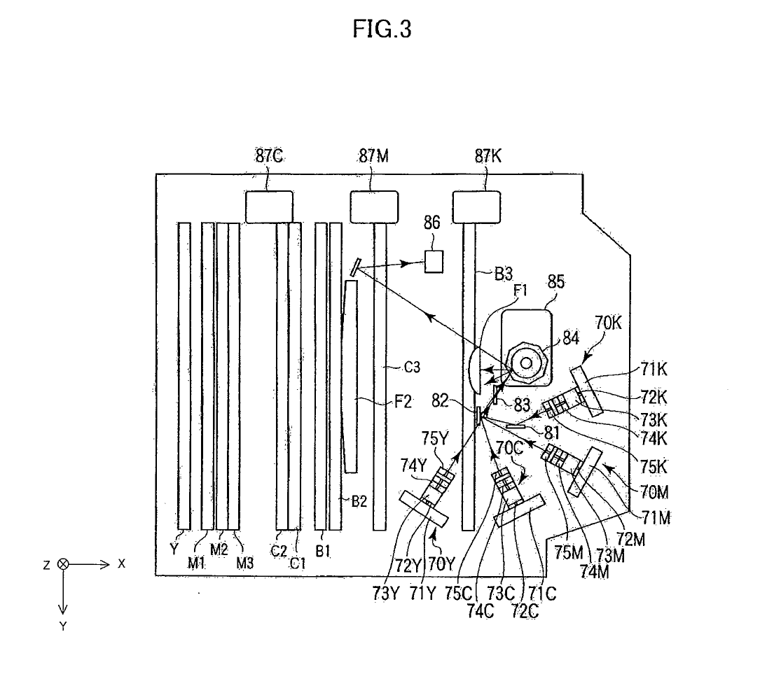

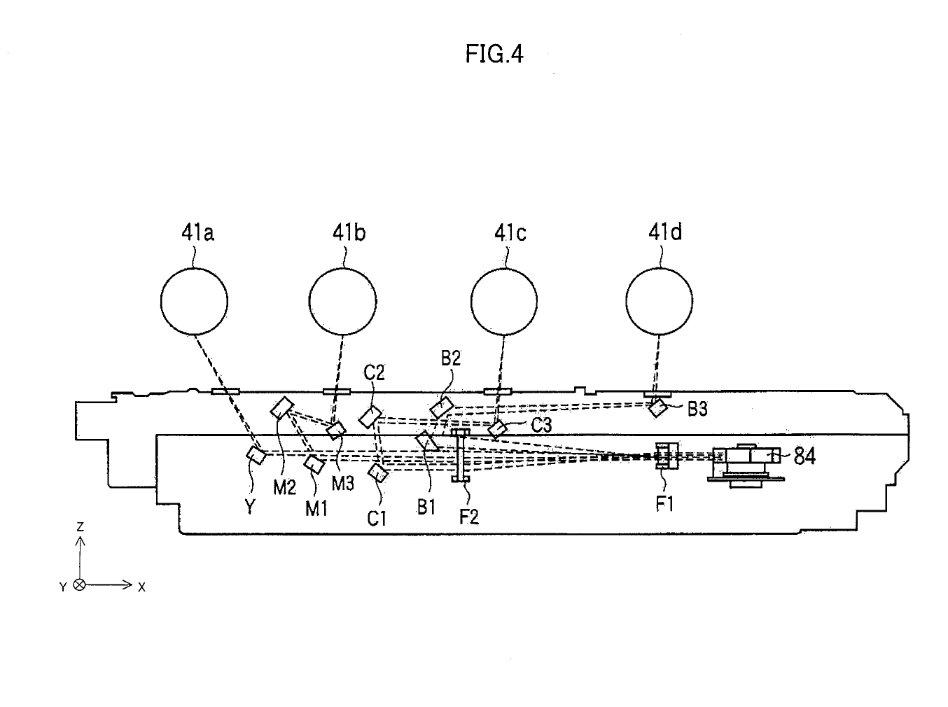

Next, the structure of the optical scanning section 40 will be described. FIG. 3 and FIG. 4 are views showing a structural example of the optical scanning section 40. FIG. 3 shows the arrangement of respective parts in the optical scanning section 40. FIG. 4 shows the structural example of an optical system in the optical scanning section 40. As shown in FIG. 3, the optical scanning section 40 includes the laser beam units 70 (70Y, 70M, 70C, 70K), three pre-deflection mirrors 81, 82 and 83, a polygon mirror 84, a polygon motor 85, two fθ lenses F1 and F2, a BD sensor 86, three mirror motors 87 (87M, 87C, 87K) and plural mirror groups Y, M1 to M3, C1 to C3 and K1 to K3.

The respective laser beam units 70 (70Y, 70M, 70C, 70K) respectively include laser drive substrates 71 (71Y, 71M, 71C, 71K), laser diode (LD) arrays 72 (72Y, 72M, 72C, 72K), finite focal lenses 73 (73Y, 73M, 73C, 73K), apertures 74 (74Y, 74M, 74C, 74K) and cylinder lenses 75 (75Y, 75M, 75C, 75K). Incidentally, the laser beam unit 70 corresponds to a light emitting section.

In each of the laser beam units 70, the laser drive substrate 71 is connected to the laser control section 68. The laser drive substrate 71 outputs a drive signal for emitting a laser beam based on an image signal from the laser control section 68. The laser drive substrate 71 causes the light emitting section in the laser diode (LID) array 72 to emit a laser beam by the drive signal. In each of the laser beam units 70, the laser diode (LD) array 72 emits a laser beam based on the drive signal outputted by the laser drive substrate 71 in accordance with the image data supplied from the laser control section 68. In the optical scanning section 40, the LD array 72 is a multi-beam array type laser diode capable of emitting plural laser beams. In this embodiment, the LID array 72 is a four-beam array type laser diode capable of emitting four laser beams. Incidentally, the structural example of the LD array 72 will be described later in detail.

Each of the laser beam units 70 emits the respective laser beams emitted from the LD array 72 through the finite focal lens 73, the aperture 74 and the cylinder lens 75. Each of the laser beam units 70 is installed so that the respective emitted laser beams are irradiated to one of the pre-deflection mirrors 81 and 82 or directly to the polygon mirror 84, and are incident on the polygon mirror 84.

For example, the laser beam unit 70K is installed so that the laser beam (laser beam for black) for forming a black image reflected by the pre-deflection mirror 81 and the pre-deflection mirror 82 is irradiated to the polygon mirror 84 through the pre-deflection lens 83. Besides, the laser beam unit 70M is installed so that the laser beam (laser beam for magenta) for forming the magenta image reflected by the pre-deflection mirror 82 is irradiated to the polygon mirror 84 through the pre-deflection lens 83. Besides, the laser beam unit 70C is installed so that the laser beam (laser beam for cyan) for forming the cyan image reflected by the pre-deflection mirror 82 is irradiated to the polygon mirror 84 through the pre-deflection lens 83. Besides, the laser beam unit 70Y is installed so that the laser beam (laser beam for yellow) for forming the yellow image is directly irradiated to the polygon mirror 84 through the pre-deflection lens 83.

The polygon mirror 84 is the mirror having multiple surfaces (eight surfaces), and is rotated by the polygon motor 85. The laser beams for the respective colors irradiated to the polygon mirror 84 are respectively scanned by the respective mirror surfaces of the polygon mirror 84 in the main scanning direction. In the optical scanning section 40, the optical system is formed so that the laser beams of the respective colors scanned by the polygon mirror 84 in the main scanning direction are guided to the surfaces of the photoconductive drums for the respective colors.

For example, a laser beam for black passing through the two fθ lenses F1 and F2 is sequentially reflected by the three mirrors for black B1, B2 and B3, and is irradiated to the photoconductive drum 41d. That is, as shown in FIG. 4, the respective mirrors for black B1, B2 and B3 are installed so that the laser beam for black scanned in the main scanning direction by the polygon mirror 84 is guided to the photoconductive drum 41d. Besides, the mirrors for black B1, B2 and B3 are constructed to be adjusted by the mirror motor 87K.

Besides, a laser beam for magenta passing through the two fθ lenses F1 and F2 is sequentially reflected by the three mirrors for magenta M1, M2 and M3, and is irradiated to the photoconductive drum 41b. That is, as shown in FIG. 4, the mirrors for magenta M1, M2 and M3 are installed so that the laser beam for magenta scanned in the main scanning direction by the polygon mirror 84 is guided to the photoconductive drum 41b. Besides, the mirrors for magenta M1, M2 and M3 are constructed to be adjusted by the mirror motor 87M.

Besides, a laser beam for cyan passing through the two fθ lenses F1 and F2 is sequentially reflected by the three mirrors for cyan C1, C2 and C3, and is irradiated to the photoconductive drum 41c. That is, as shown in FIG. 4, the mirrors for cyan C1, C2 and C3 are installed so that the laser beam for cyan scanned in the main scanning direction by the polygon mirror 84 is guided to the photoconductive drum 41c. Besides, the positions of the mirrors for cyan C1, C2 and C3 are adjusted by driving the mirror motor 87C.

Besides, a laser beam for yellow passing through the two fθ lenses F1 and F2 is sequentially reflected by the one mirror for yellow Y, and is irradiated to the photoconductive drum 41a. That is, as shown in FIG. 4, the mirror for yellow Y is installed so that the laser beam for yellow scanned in the main scanning direction by the polygon mirror 84 is guided to the photoconductive drum 41a. Incidentally, here, the installation position of the mirror for yellow Y is fixed.

As described above, the laser beams emitted from the respective laser beam units are reflected by the plural mirrors before they reach the photoconductive drums 41. The structure of the optical system to guide the respective laser beams to the respective photoconductive drums 41 is determined by the structure of the respective parts in the image forming apparatus. For example, it is conceivable that in the image forming apparatus, the installation condition (for example, an area where the installation can be performed) of the optical scanning section 40 is different for each machine type of image forming apparatus. Besides, the number of installed mirrors or installation positions in the optical scanning section 40 can be changed also by the structure of the LD array itself.

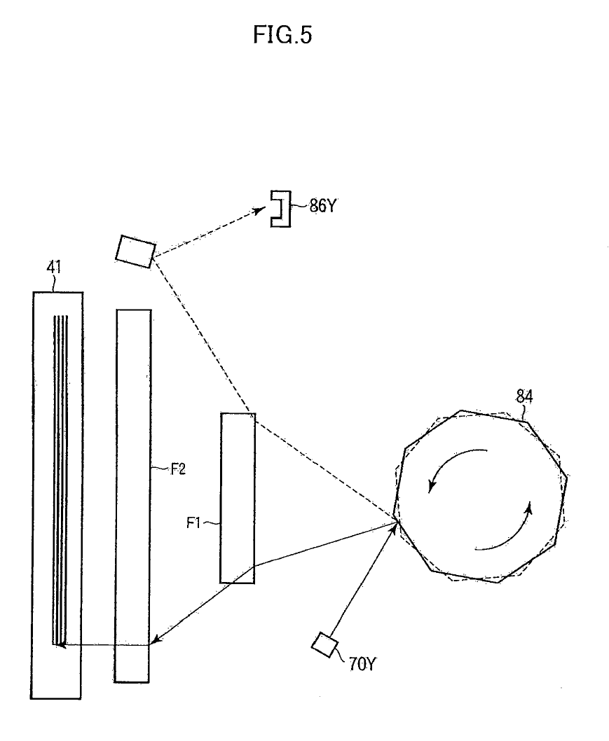

Next, scanning of a laser beam in the optical scanning section 40 will be described. FIG. 5 is a view for explaining the scanning of the laser beam in the optical scanning section 40. FIG. 5 schematically shows a scanning path of the laser beam for yellow. In FIG. 5, the laser beam unit 70M for magenta, the laser beam unit 70C for cyan, the laser beam unit 70K for black, the pre-deflection mirrors 81 and 82, the pre-deflection lens 83, the mirrors Y, M1 to M3, C1 to C3 and K1 to K3 for the respective colors and the like are omitted.

As shown in FIG. 5, in the optical scanning section 40, the laser beam emitted from the laser beam unit 70 is reflected by the polygon mirror 84, and is irradiated to the photoconductive drum 41 through the fθ lenses F1 and F2 and the like. As described above, the polygon mirror 84 rotated by the polygon motor 85 performs one scan of the laser beam in the main scanning direction by the mirror of one surface. By this, an electrostatic latent image is formed on the photoconductive drum 41 by the laser beam scanned in the main scanning direction. Besides, a desired interval in the sub-scanning direction is provided between the laser beams to scan the photoconductive drum 41 in the main scanning direction. For example, the interval between plural light emitting elements in the LD array 72 of the laser beam unit 70 described later is designed to correspond to the interval in the sub-scanning direction.

The BD sensor 86 is installed to generate a BD signal (or also called a HSYNC signal) each time the sensor detects that the laser beam is scanned once in the main scanning direction. Plural BD sensors 86 may be provided for each color, or the BD sensor may be installed to detect only a laser beam corresponding to a specified color (for example, yellow or black). FIG. 5 shows the structural example in which the BD sensor 86 to detect the beam for the specific color is provided. Besides, in the structural example shown in FIG. 5, the BD mirror to guide the desired laser beam to the BD sensor 86 is installed. Besides, the BD mirror is installed to guide the desired laser beam passing through the upstream side of the second fθ lens F2 in the main scanning direction to the BD sensor 86. By the structure as stated above, in the optical scanning section 40, the timing when the laser beam starts to scan in the main scanning direction can be measured based on the BD signal detected by the BD sensor 86.

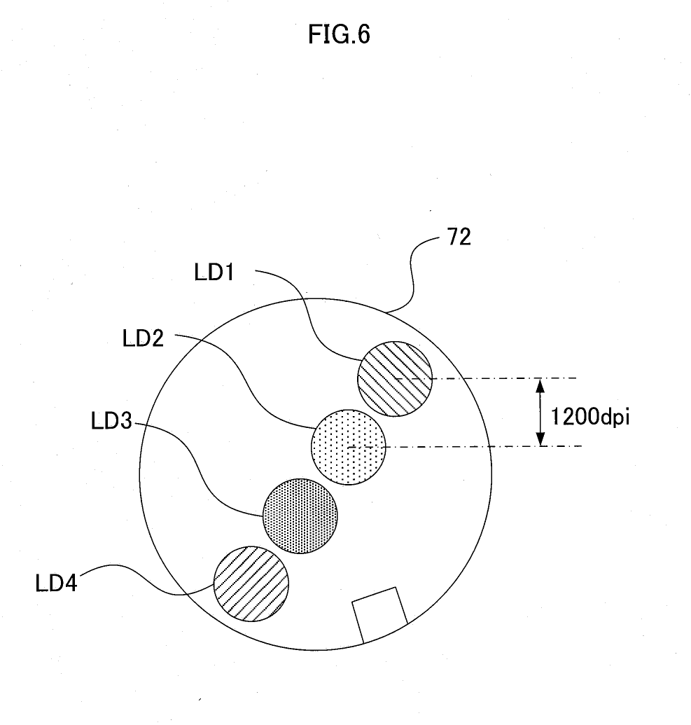

Next, the structure of the LD array 72 in the laser beam unit 70 will be described. FIG. 6 is a view showing the structural example of the LD array 72 in the laser beam unit 70. Each of the laser beam units 70 includes the LD array 72 having a function to simultaneously emit plural laser beams. In the structural example shown in FIG. 6, the LD array 72 includes four light emitting sections (four laser diodes) LD1 to LD4 to emit four laser beams. The LD array 72 is designed on the assumption that the respective light emitting elements LD1 to LD4 are obliquely arranged.

That is, the LD array 72 is designed to have such a state (for example, a state inclined by 45 degrees) that the four light emitting elements LD1 to LD4 to emit four laser beams are arranged obliquely with respect to the main scanning direction. Besides, the LD array 72 is designed so that the interval in the sub-scanning direction becomes a desired interval (for example, 1200 dpi) in the state arranged obliquely with respect to the main scanning direction.

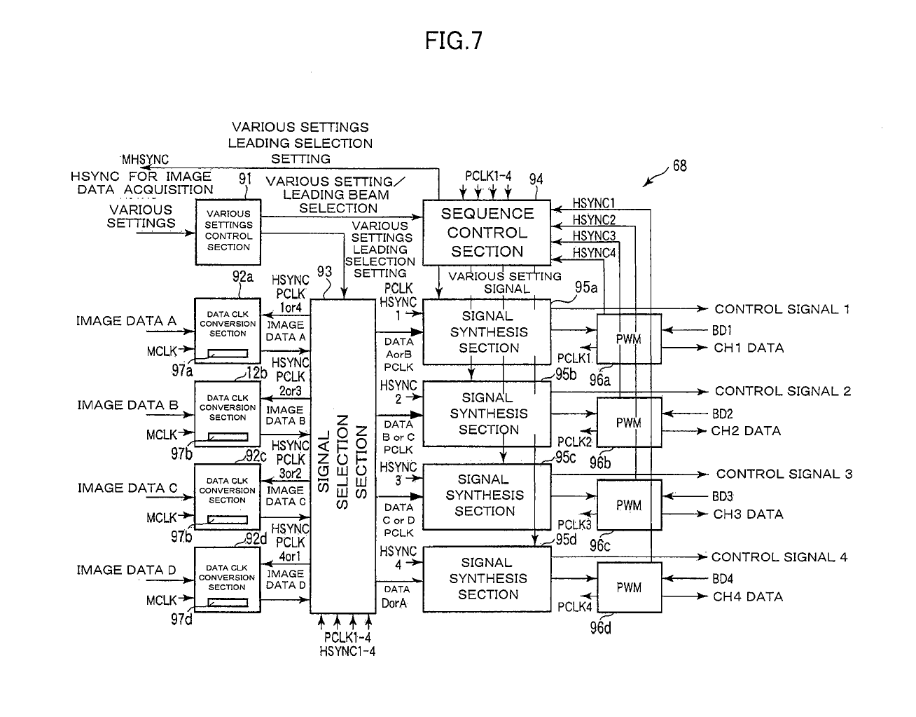

Next, the structure of the laser control section 68 for each color connected to the laser beam unit 70 for each color will be described in detail. FIG. 7 is a view showing the structural example of the laser control section 68 for each color. As shown in FIG. 7, the laser control section 68 is provided for each of colors (for example, four colors of Y, M, C and K) for forming an image. The laser control section 68 is formed of, for example, an integrated circuit (ASIC) provided on a substrate. The laser control section 68 is physically and electrically connected to the laser beam unit 70 for each color.

In the structural example shown in FIG. 7, the laser control section 68 includes a multi-setting control section 91, four data clock (CLK) conversion sections 92 (92a, 92b, 92c, 92d), a signal selection section 93, a sequence control section 94, four signal synthesis sections 95 (95a, 95b, 95c, 95d) and four PWM (Pulse Wide Modulation) sections 96 (96a, 96b, 96c, 96d). Incidentally, the laser control section 68 of the structural example shown in FIG. 7 corresponds to the laser beam unit 70 including the four-beam type LD array 72. Thus, the laser control section 68 includes the four data CLK conversion sections 92, the four signal synthesis sections 95, and the four PWM sections 96 as the components for individually controlling the respective laser beams.

The multi-setting control section 91 performs control in the laser control section 68. The multi-setting control section 91 performs, for example, various settings to the signal selection section 93 and the sequence control section 94. The multi-setting control section 91 receives information indicating various settings from the CPU 61 as the upper control device, and outputs the setting information to the signal selection section 93 and the sequence control section 94. That is, the multi-setting control section 91 functions not only as the control element such as the CPU but also as the interface.

The data CLK conversion section 92 is for adjusting the timing when data is outputted. Image data for one laser beam is inputted to each of the data CLK conversion sections 92. In the example shown in FIG. 7, image data A, B, C and D are respectively inputted to the data CLK conversion sections 92a, 92b, 92c and 92d in synchronization with M clock (CLK) signals. The image data inputted to the respective data conversion sections 92 are supplied from the output image processing section 66. The laser control section 68 and the output image processing section 66 are physically connected through a specified connector (harness) or the like, and specified image data are inputted to the respective data CLK conversion sections 92. That is, the image data inputted to the respective data CLK conversion sections 92 are the image data previously determined irrespective of the connection state to the laser beam units.

Each of the data CLK conversion sections 92 includes an inner memory 97 (97a, 97b, 97c, 97d) to store image data of at least one line in the main scanning. The data CLK conversion section 92 outputs the image data stored in the inner memory 97 based on the P clock (CLK) signal selected by the signal selection section 93 and the horizontal synchronization signal (HSYNC signal). That is, the data CLK conversion section 92 outputs the image data, which is inputted in synchronization with the MCLK signal, based on the PCLK signal synchronization with the HSYNC signal selected by the signal selection section 93.

This means that the data CLK conversion section 92 has the function to convert the clock signal of the image data into the clock signal selected by the signal selection section 93 and to output the image data based on the HSYNC signal selected by the signal selection section 93. As a result, as the laser control section 68, the clock conversion corresponding to the respective parts of the latter stage and the timing control are realized without adding a component such as a memory for buffer.

The signal selection section 93 selects image data to be supplied to the respective signal synthesis sections 95 from the four image data A, B, C and D acquired from the respective data CLK conversion sections 92 based on the setting information given from the multi-setting control section 91. The image data supplied to the respective signal synthesis sections 95 are selected based on the setting information (for example, order in the sub-scanning direction) given from the multi-setting control section 91. For example, when a laser beam as a control object of the PWM section 96a is the first in the sub-scanning direction, the signal selection section 93 selects the image data A as the image data supplied to the signal synthesis section 95a corresponding to the PWM section 96a.

Besides, the signal selection section 93 receives the four P clock (CLK) signals and the four horizontal synchronization (HSYNC) signals, and selects the PCLK signals and the HSYNC signals for reading image data from the respective data CLK conversion sections 92 and supplying them to the respective signal synthesis sections 95. The PCLK signal and the HSYNC signal for reading the image data are selected based on the setting information (for example, order in the main scanning direction) given from the multi-setting control section 91. For example, when the clock signal of the laser beam as the control object of the PWM section 96a is PCLK signal 1, and order of the laser beam in the main scanning direction is the first, the signal selection section 93 selects PCLK signal 1 and HSYNC signal 1 as the signals for reading the image data A to be supplied to the signal synthesis section 95a corresponding to the PWM section 96a.

The PCLK signals 1 to 4 are the clock signals independently set according to the laser beams as the control objects of the respective PWM sections 96. This is because when all the laser beams are controlled by the same clock signal, a shift actually often occurs due to the components (respective mirrors or lenses) of the optical system of the respective laser beams. Thus, as the PCLK signals 1 to 4, the clock signals suitable for the respective laser beams L1 to L4 as the control objects of the respective PWM sections 96 are set. Besides, the HSYNC signals 1 to 4 are the signals as reference for the timing of outputting the image data, and in the signal selection section 93, the HSYNC signals are used as the reference signals for reading the selected image data from the inner memories 97 of the respective data acquisition sections 92 and supplying them to the respective signal synthesis sections 95.

In the structural example shown in FIG. 7, the signal selection section 93 selects the image data A or the image data D as the data to be supplied to the signal synthesis section 95a. For example, the signal selection section 93 reads the selected image data from the data acquisition section 92a (or 92d) at the timing when the PCLK signal 1 is synchronized with the HSYNC signal 1 (or the PCLK signal 4 is synchronized with the HSYNC signal 4) and outputs it to the signal synthesis section 95a. Besides, the signal selection section 93 selects the image data B or the image data C as the data to be supplied to the signal synthesis section 95b, reads the selected image data from the data acquisition section 92b (or 92c) at the timing when the PCLK signal 2 is synchronized with the HSYNC signal 2 (or the PCLK signal 3 is synchronized with the HSYNC signal 3) and outputs it to the signal synthesis section 95b.

Besides, the signal selection section 93 selects the image data C or the image data B as the data to be supplied to the signal synthesis section 95c, reads the selected image data from the data acquisition section 92c (or 92d) at the timing when the PCLK signal 3 is synchronized with the HSYNC signal 3 (or the PCLK signal 2 is synchronized with the HSYNC signal 2) and outputs it to the signal synthesis section 95c. Besides, the signal selection section 93 selects the image data D or the image data A as the data to be supplied to the signal synthesis section 95d, and reads the selected image data from the data acquisition section 92d (or 92a) at the timing when the PCLK signal 4 is synchronized with the HSYNC signal 4 (or the PCLK signal 1 is synchronized with the HSYNC signal 1) and outputs it to the signal synthesis section 95d.

The sequence control section 94 supplies various setting information based on the setting information given from the multi-setting control section 91 to the respective signal synthesis sections 95 (95a, 95b, 95c, 95d). For example, in the structural example shown in FIG. 7, the sequence control section 94 is supplied with the setting information indicating the leading laser beam, together with the setting information to the respective signal synthesis sections 95, from the multi-setting control section 91. By this, the sequence control sections 94 respectively supply the setting signals to the respective signal synthesis sections 95a, 95b, 95c and 95d.

Besides, the four P clock (CLK) signals and the horizontal synchronization (HSYNC) signals are inputted to the sequence control section 94. For example, the PCLK signals 1 to 4 and the HSYNC signals 1 to 4 are supplied to the sequence control section 94 from the respective PWM sections 96. Further, the sequence control section 94 outputs, as MHSYNC signals, the HSYNC signals for image data acquisition based on the HSYNC signals 1 to 4 acquired from the respective PWM sections 96 to the output image processing section 66 or the upper control device.

The signal synthesis sections 95a, 95b, 95c and 95d and the PWM sections 96a, 96b, 96c and 96d respectively correspond to the four laser beams. In the foregoing structural example, the signal synthesis section 95a and the PWM section 96a correspond to the laser beam L1 or L4, the signal synthesis section 95b and the PWM section 96b correspond to the laser beam L2 or L3, the signal synthesis section 95c and the PWM section 96c correspond to the laser beam L3 or L2, and the signal synthesis section 95d and the PWM section 96d correspond to the laser beam L4 or L1.

The respective signal synthesis sections 95 (95a, 95b, 95c, 95d) respectively supply the image data supplied from the signal selection section 93 to the respective PWM sections 96 based on the setting information given from the sequence control section 94. Besides, the respective signal synthesis sections 95 output the control signals to control the light emission of the respective laser beams in the laser beam unit 70.

The respective signal synthesis sections 95 correspond to the four laser beams. However, the laser beams corresponding to the respective signal synthesis sections are changed according to the connection state of the laser beam unit 70. That is, the respective signal synthesis sections 95 are supplied with the image data to be formed by the corresponding laser beams from the signal selection section 93. Besides, the respective signal synthesis sections 95 output the image data from the signal selection section 93 to the respective PWM sections 96 at the timings given from the sequence control section 94.

The respective PWM sections 96 (96a, 96b, 96c, 96d) are provided correspondingly to the respective signal synthesis sections 95 (95a, 95b, 95c, 95d). The respective PWM sections 96 output signals to control the laser beams in accordance with the image data given from the corresponding signal synthesis sections 95. Besides, the respective PWM sections 96 acquire BD signals detected by the BD sensor 86 and generate the HSYNC signals used for the control of the laser beams. For example, the PWM section 96a supplies, as HSYNC signal 1, BD signal 1 detected by the BD sensor 86 to the sequence control section 94. Similarly, the PWM sections 96b, 96c and 96d supply, as HSYNC signals 2, 3 and 4, BD signals 2, 3 and 4 detected by the BD sensor 86 to the sequence control section 94.

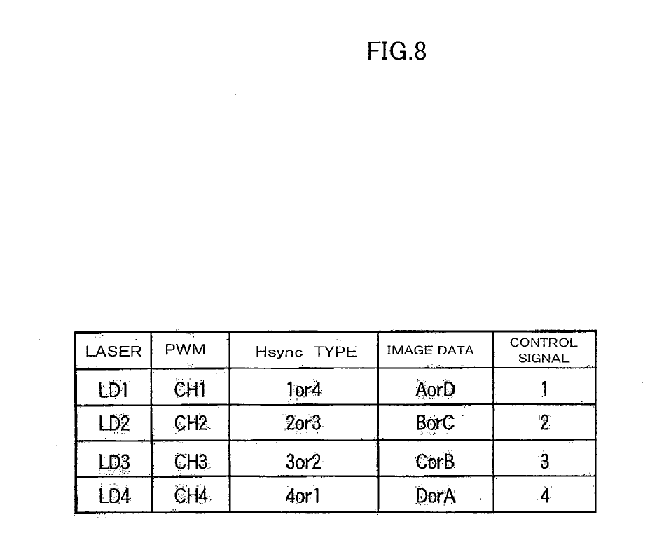

FIG. 8 is a view in which the operations and setting items in the laser control section 68 shown in FIG. 7 are summarized. As shown in FIG. 8, in the laser control section 68 shown in FIG. 7, the HSYNC order can be selected and the image data can be replaced. For example, the PWM section 96a is set such that the image data outputted as CH1 is the image data A or D, and the HSYNC order is the first or the fourth. Besides, the PWM section 96b is set such that the image data outputted as CH2 is the image data B or C, and the HSYNC order is the second or the third. Besides, the PWM section 96c is set such that the image data outputted as CH3 is the image data C or B, and the HSYNC order is the third or the second. Besides, the PWM section 96d is set such that the image data outputted as CH4 is the image data D or A, and the HSYNC order is the fourth or the first.

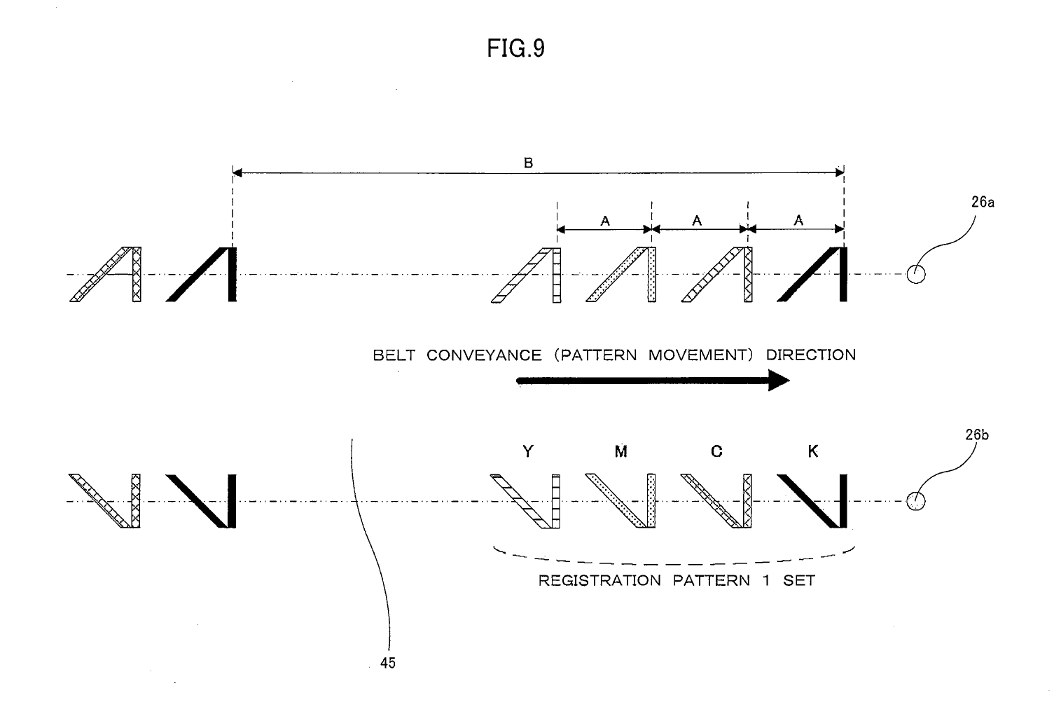

Next, the position shift sensor 26 will be described in detail with reference to FIG. 9. FIG. 9 is a plan view of the transfer belt 45. The position shift sensor 26 includes a rear side position shift sensor 26a and a front side position shift sensor 26b which respectively detect test patterns (first test images) formed at both ends of the transfer belt 45 in the main scanning direction. The rear side position shift sensor 26a detects the test pattern formed at one end of the transfer belt 45 in the main scanning direction, and the front side position shift sensor 26b detects the test pattern formed at the other end of the transfer belt 45 in the main scanning direction. The test pattern is formed such that plural wedge-shaped figures formed using yellow (Y), magenta (M), cyan (C) and black (K) are arranged in the sub-scanning direction. Each of the wedge-shaped figures includes a line segment extending in the main scanning direction and a line segment extending in an oblique direction with respect to the main scanning direction.

The CPU 61 performs the registration control based on the detection result of the rear side position shift sensor 26a and the front side position shift sensor 26b. Here, the registration control means correcting a parallel shift in the sub-scanning direction, a writing position shift in the main scanning direction, a main scanning magnification adjustment, and an inclination. The registration in the sub-scanning direction is performed by changing the leading line data output start timing of each color. The registration of the writing position in the main scanning direction is performed by changing the laser writing position.

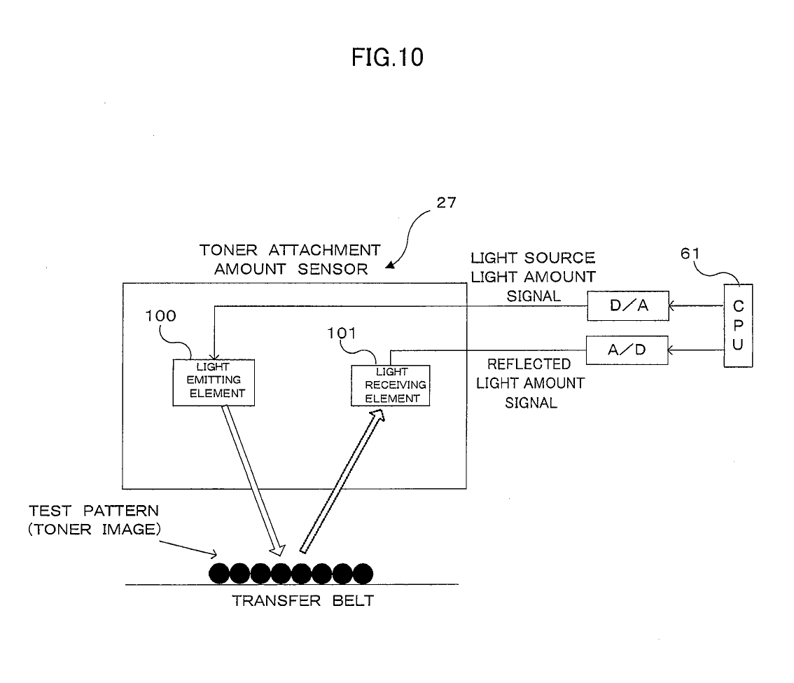

Next, the density sensor 27 will be described in detail with reference to FIG. 10. The density sensor 27 includes a light emitting element 100 and a light receiving element 101, and is used for image quality maintenance. A light source control voltage corresponding to the light amount specified by the CPU 61 is outputted from a D/A converter, and the light emitting element 100 emits the light corresponding to the light amount control voltage to the transfer belt 45. The light receiving element 101 receives reflected light reflected by the transfer belt 45 and the toner image formed on the transfer belt 45. The output voltage corresponding to the amount of the reflected light is converted into a digital value by an A/D converter and is transmitted to the CPU 61.

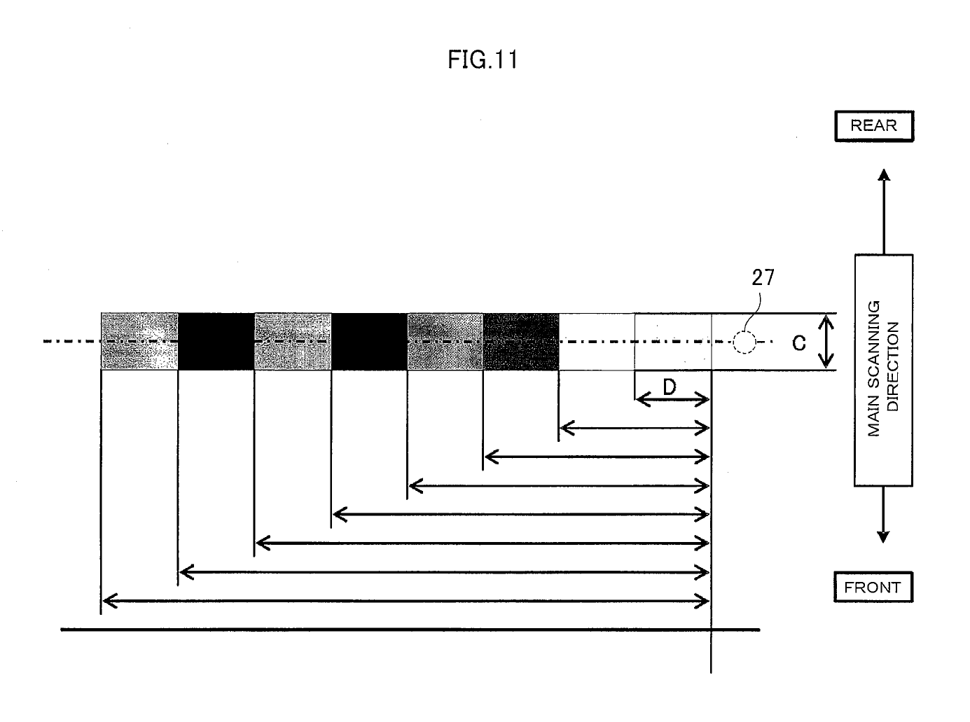

FIG. 11 shows a test pattern for detecting the density of a toner image formed on the transfer belt 45. The test pattern is constructed by forming plural toner images whose densities are changed for the respective colors of yellow (Y), magenta (M), cyan (C) and black (K). The toner images for density detection are formed at the center of the transfer belt 45 in the main scanning direction. The CPU 61 compares the density of the detected test pattern with the reference value and determines whether it is within an allowable range in which trouble does not occur in the image formation. When it is outside the allowable range, the image formation condition is changed. By this, image quality maintenance can be realized.

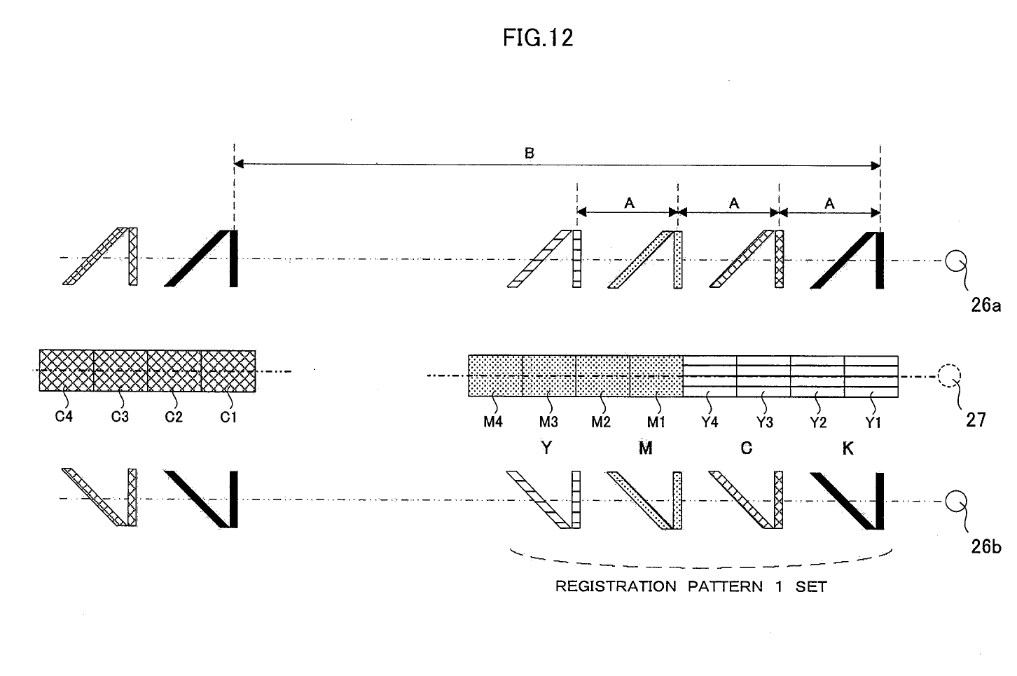

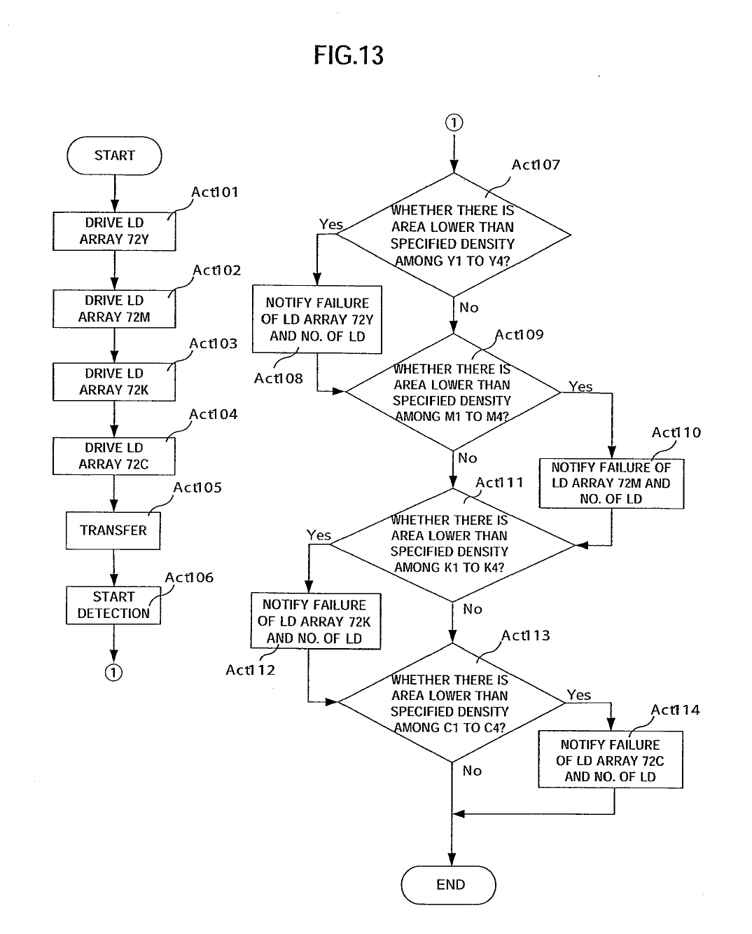

In this embodiment, the density sensor 27 used for image quality maintenance is used also for the failure detection of the laser beam unit 70. The failure detection is performed in parallel to the registration control using the position shift sensor 26. The method of the failure detection will be described in detail with reference to FIG. 12 and FIG. 13. FIG. 12 is a schematic view showing a test pattern (first test image) for registration and a test pattern (second test image) for failure detection. FIG. 13 is a flowchart showing the method of the failure detection. Since the test pattern for registration is described above, its description is not repeated.

At Act 101, the CPU (failure determination section) 61 drives LD1, LD2, LD3 and LD4 of the LD array 72Y in this order, and forms electrostatic latent images corresponding to toner images Y1 to Y4 of FIG. 12 on the first photoconductive drum 41a. Here, the toner image Y1 corresponds to the LD1 of the LD array 72Y, and is formed by performing scanning of the LD1 plural times. The toner image Y2 corresponds to the LD2 of the LD array 72Y, and is formed by performing scanning of the LD2 plural times. The toner image Y3 corresponds to the LD3 of the LD array 72Y, and is formed by performing scanning of the LD3 plural times. The toner image Y4 corresponds to the LD4 of the LD array 72Y, and is formed by performing scanning of the LD4 plural times.

At Act 102, the controller 61 drives LD1, LD2, LD3 and LD4 of the LD array 72M in this order, and forms electrostatic latent images corresponding to toner images M1 to M4 of FIG. 12 on the second photoconductive drum 41b. Here, the toner image M1 corresponds to the LD1 of the LD array 72M, and is formed by performing scanning of the LD1 plural times. The toner image M2 corresponds to the LD2 of the LD array 72M, and is formed by performing scanning of the LD2 plural times. The toner image M3 corresponds to the LD3 of the LD array 72M, and is formed by performing scanning of the LD3 plural times. The toner image M4 corresponds to the LD4 of the LD array 72M, and is formed by performing scanning of the LD4 plural times.

At Act 103, the controller 61 drives LD1, LD2, LD3 and LD4 of the LD array 72K in this order, and forms electrostatic latent images corresponding to toner images K1 to K4 on the third photoconductive drum 41c. Here, the toner image K1 corresponds to the LD1 of the LD array 72K, and is formed by performing scanning of the LD1 plural times. The toner image K2 corresponds to the LD2 of the LD array 72K, and is formed by performing scanning of the LD2 plural times. The toner image K3 corresponds to the LD3 of the LD array 72K, and is formed by performing scanning of the LD3 plural times. The toner image K4 corresponds to the LD4 of the LD array 72K, and is formed by performing scanning of the LD4 plural times.

At Act 104, the controller 61 drives LD1, LD2, LD3 and LD4 of the LD array 72C in this order, and forms electrostatic latent images corresponding to toner images C1 to C4 on the fourth photoconductive drum 41d. Here, the toner image C1 corresponds to the LD1 of the LD array 72C, and is formed by performing scanning of the LD1 plural times. The toner image C2 corresponds to the LD2 of the LD array 72C, and is formed by performing scanning of the LD2 plural times. The toner image C3 corresponds to the LD3 of the LD array 72C, and is formed by performing scanning of the LD3 plural times. The toner image C4 corresponds to the LD4 of the LD array 72C, and is formed by performing scanning of the LD4 plural times.

At Act 105, the toner images (that is, the respective test patterns) of the respective colors formed on the respective photoconductive drums 41a to 41d are sequentially transferred to the transfer belt 45 as an intermediate transfer body. When the test patterns are transferred to the transfer belt 45, the test patterns detected by the position shift sensor 26 are also simultaneously transferred.

At Act 106, the detection operation of the position shift sensor 26 and the density sensor 27 is started.

At Act 107, the CPU 61 determines whether there is a toner image whose density is lower than a specified density among the toner images Y1 to Y4 formed on the transfer belt 45. When there is a toner image whose density is lower than the specified density, advance is made to ACT 108. Here, the “specified density” is a value which is set according to the color of the toner, and is suitably set from the viewpoint that the failure of the LD as the light emitting element is determined. Accordingly, the value of the specified density varies according to the toner of Y, M, C and K.

At ACT 108, the CPU 61 outputs a signal to a notification unit (not shown). The notification unit notifies that the LD array 72 is broken. As the notification unit, a unit can be used which displays identification information indicating the color of the broken LD array 72 and No. of the LD on a not-shown touch panel display of the color digital multi-function peripheral 1, or communicates the identification information to a management center through the Internet.

At Act 107, when it is determined that there is no toner image whose density is lower than the specified density, advance is made to Act 109. At Act 109, the CPU 61 determines whether there is a toner image whose density is lower than a specified density among the toner images M1 to M4 formed on the transfer belt 45. When there is a toner image whose density is lower than the specified density, advance is made to Act 110. At Act 110, the CPU 61 outputs a signal to the notification unit. Since the details of the notification unit is described above, its description is not repeated.

At Act 109, when it is determined that there is no toner image whose density is lower than the specified density, advance is made to Act 111. At Act 111, the CPU 61 determines whether there is a toner image whose density is lower than a specified density among the toner images K1 to K4 formed on the transfer belt 45. When there is a toner image whose density is lower than the specified density, advance is made to Act 112. At Act 112, the CPU 61 outputs a signal to the notification unit. Since the details of the notification unit is described above, its description is not repeated.

At Act 111, when it is determined that there is no toner image whose density is lower than the specified density, advance is made to Act 113. At Act 113, the CPU 61 determines whether there is a toner image whose density is lower than a specified density among the toner images C1 to C4 formed on the transfer belt 45. When there is a toner image whose density is lower than the specified density, advance is made to Act 114. At Act 114, the CPU 61 outputs a signal to the notification unit. Since the details of the notification unit is described above, its description is not repeated.

As described above, according to this embodiment, the presence or absence of failure can be determined on all the arrays 72 by acquiring the density information of the toner images formed on the transfer belt 45. Accordingly, it is not necessary to print an image on a sheet in order to determine the failure unlike in the related art.

Here, as described above, in this embodiment, the position shift detection using the position shift sensor 26 and the failure detection of the laser beam units 70 using the density sensor 27 are performed in parallel. Accordingly, as compared with the method in which these detections are separately performed, the down time of the digital multi-function peripheral 1 can be shortened.

Besides, since the failure detection is performed using the density sensor 27 used for image quality maintenance, it is not necessary to independently provide a sensor for failure detection. By this, the cost can be reduced.

### Embodiment 2

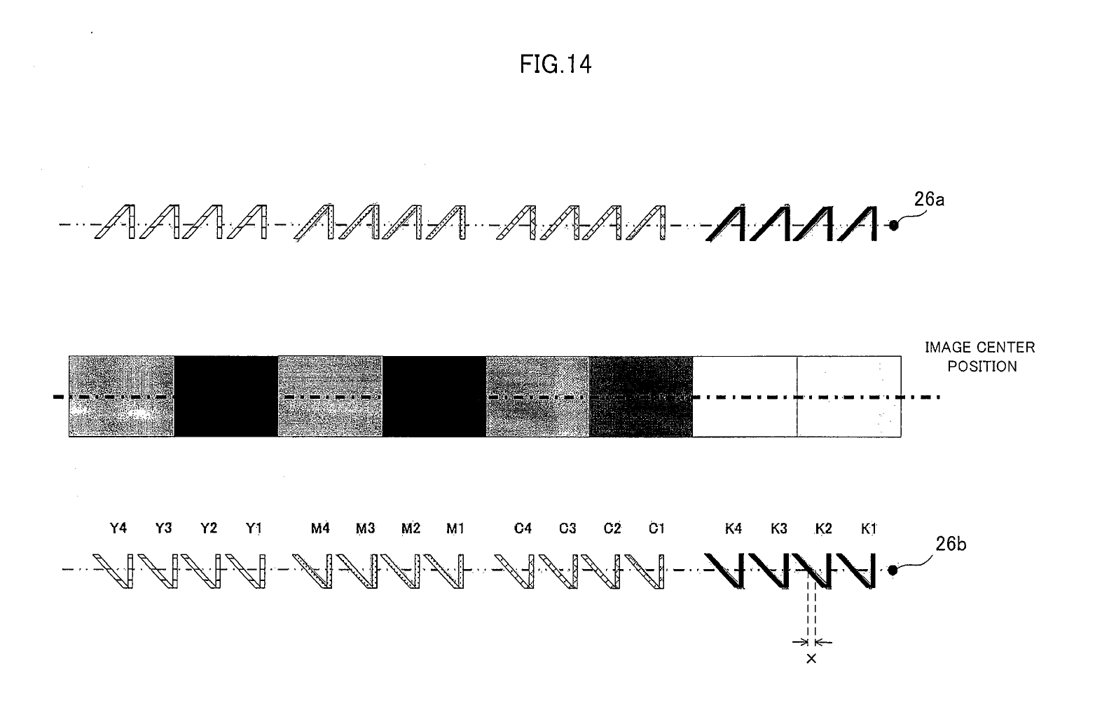

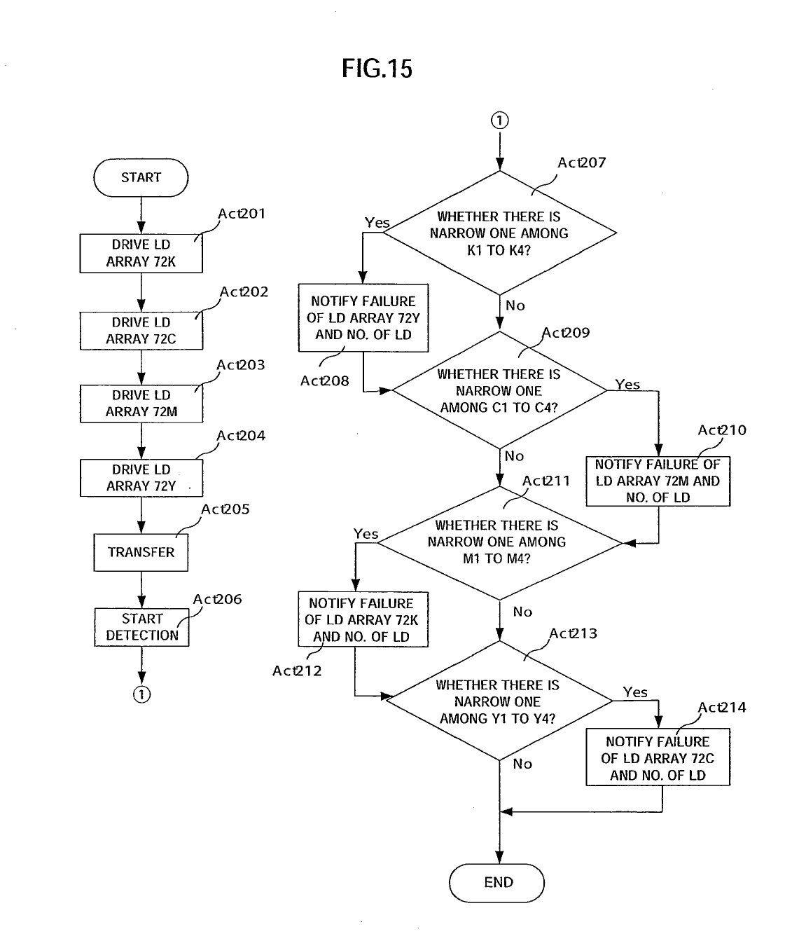

In the embodiment 1, the failure is detected using the density sensor 27 used for the image quality maintenance. In this embodiment, the failure is detected using the position shift sensor 26. The failure detection is performed in parallel to the image quality control using the density sensor 27. The method of the failure detection will be described in detail with reference to FIG. 14 and FIG. 15. FIG. 14 is a schematic view showing a test pattern for image quality maintenance and a test pattern for failure detection. FIG. 15 is a flowchart showing the method of the failure detection. Since the test pattern for image quality maintenance is described above, its description is not repeated.

At Act 201, the CPU 61 drives the LD1, LD2, LD3 and LD4 of the LD array 72K in this order, and forms electrostatic latent images corresponding to wedge-shaped toner images K1 to K4 shown in FIG. 14 on the fourth photoconductive drum 41d. Here, the toner image K1 (second test image) corresponds to the LD1 of the LD array 72K, and is formed by performing scanning of the LD1 plural times. The toner image K2 (second test image) correspond to the LD2 of the LD array 72K, and is formed by performing scanning of the LD2 plural times. The toner image K3 (second test image) corresponds to the LD3 of the LD array 72K, and is formed by performing scanning of the LD3 plural times. The toner image K4 (second test image) corresponds to the LD4 of the LD array 72K, and is formed by scanning the LD4 plural times.

At Act 202, the controller 61 drives the LD1, LD2, LD3 and LD4 of the LD array 72C in this order, and forms electrostatic latent images corresponding to wedge-shaped toner images C1 to C4 shown in FIG. 14 on the third photoconductive drum 41c. Here, the toner image C1 (second test image) corresponds to the LD1 of the LD array 72C, and is formed by performing scanning of the LD1 plural times. The toner image C2 (second test image) correspond to the LD2 of the LD array 72C, and is formed by performing scanning of the LD2 plural times. The toner image C3 (second test image) corresponds to the LD3 of the LD array 72C, and is formed by performing scanning of the LD3 plural times. The toner image C4 (second test image) corresponds to the LD4 of the LD array 72C, and is formed by performing scanning of the LD4 plural times.

At Act 203, the controller 61 drives the LD1, LD2, LD3 and LD4 of the LD array 72M in this order, and forms electrostatic latent images corresponding to wedge-shaped toner images M1 to M4 shown in FIG. 14 on the second photoconductive drum 41b. Here, the toner image M1 (second test image) corresponds to the LD1 of the LD array 72M, and is formed by performing scanning of the LD1 plural times. The toner image M2 (second test image) correspond to the LD2 of the LD array 72M, and is formed by performing scanning of the LD2 plural times. The toner image M3 (second test image) corresponds to the LD3 of the LD array 72M, and is formed by performing scanning of the LD3 plural times. The toner image M4 (second test image) corresponds to the LD4 of the LD array 72M, and is formed by performing scanning of the LD4 plural times.

At Act 204, the controller 61 drives the LD1, LD2, LD3 and LD4 of the LD array 72Y in this order, and forms electrostatic latent images corresponding to wedge-shaped toner images Y1 to Y4 shown in FIG. 14 on the first photoconductive drum 41a. Here, the toner image Y1 (second test image) corresponds to the LD1 of the LD array 72Y, and is formed by performing scanning of the LD1 plural times. The toner image Y2 (second test image) correspond to the LD2 of the LD array 72Y, and is formed by performing scanning of the LD2 plural times. The toner image Y3 (second test image) corresponds to the LD3 of the LD array 72Y, and is formed by performing scanning of the LD3 plural times. The toner image Y4 (second test image) corresponds to the LD4 of the LD array 72Y, and is formed by performing scanning of the LD4 plural times.

At Act 205, the toner images of the respective colors formed on the respective photoconductive drums 41a to 41d are sequentially transferred to the transfer belt 45 as the intermediate transfer body. Incidentally, when the toner images are transferred to the transfer belt 45, it is assumed that test patterns (first test images) detected by the density sensor 27 are also formed.

At Act 206, the detection operation of the position shift sensor 26 and the density sensor 27 is started. At Act 207, the CPU 61 determines whether there is a toner image whose line width X in the sub-scanning direction is smaller than a specified value among the toner images K1 to K4 formed on the transfer belt 45. When there is a toner image whose line width is smaller than the specified value, advance is made to ACT 208.

At Act 208, the CPU 61 outputs a signal to a notification unit (not shown). The notification unit notifies that the LD array 72 is broken. As the notification unit, a unit can be used which displays identification information indicating the color of the broken LD array 72 and No. of the LD on a not-shown touch panel display of the color digital multi-function peripheral 1, or communicates the identification information to a management center through the Internet.

At Act 207, when it is determined that there is no toner image whose line width X is smaller than the specified value, advance is made to Act 209. At Act 209, the CPU 61 determines whether there is a toner image whose line width X in the sub-scanning direction is smaller than a specified value among the toner images C1 to C4 formed on the transfer belt 45. When there is a toner image whose line width is smaller than the specified value, advance is made to Act 210. At Act 210, the CPU 61 outputs a signal to the notification unit. Since the details of the notification unit is described above, its description is not repeated.

At Act 209, when there is no toner image whose line width is smaller than the specified value, advance is made to Act 211. At Act 211, the CPU 61 determines whether there is a toner image whose line width X in the sub-scanning direction is smaller than a specified value among the toner images M1 to M4 formed on the transfer belt 45. When there is a toner image whose line width is smaller than the specified value, advance is made to Act 212. At Act 212, the CPU 61 outputs a signal to the notification unit. Since the details of the notification unit is described above, its description is not repeated.

At Act 211, when there is no toner image whose line width is smaller than the specified value, advance is made to Act 213. At Act 213, the CPU 61 determines whether there is a toner image whose line width X in the sub-scanning direction is smaller than a specified value among the toner images Y1 to Y4 formed on the transfer belt 45. When there is a toner image whose line width is smaller than the specified value, advance is made to Act 214. At Act 214, the CPU 61 outputs a signal to the notification unit. Since the details of the notification unit is described above, its description is not repeated.

As described above, according to the structure of this embodiment, the failures of the LDs included in all the LD arrays 72 can be determined by acquiring the density information of the toner images formed on the transfer belt 45. Accordingly, it is not necessary to print an image on a sheet in order to determine the failure unlike in the related art.

Here, as described above, in this embodiment, the image quality maintenance based on the detection result of the density sensor 27 and the failure detection of the laser beam units 70 using the position shift sensor 26 are performed in parallel. Accordingly, as compared with a method in which these detections are separately performed, the down time of the digital multi-function peripheral 1 can be shortened.

Besides, since the failure detection is performed by using the position shift sensor 26 for registration control, it is not necessary to independently provide a sensor for failure detection. By this, the cost can be reduced.

### Modified Example of the Embodiment 2

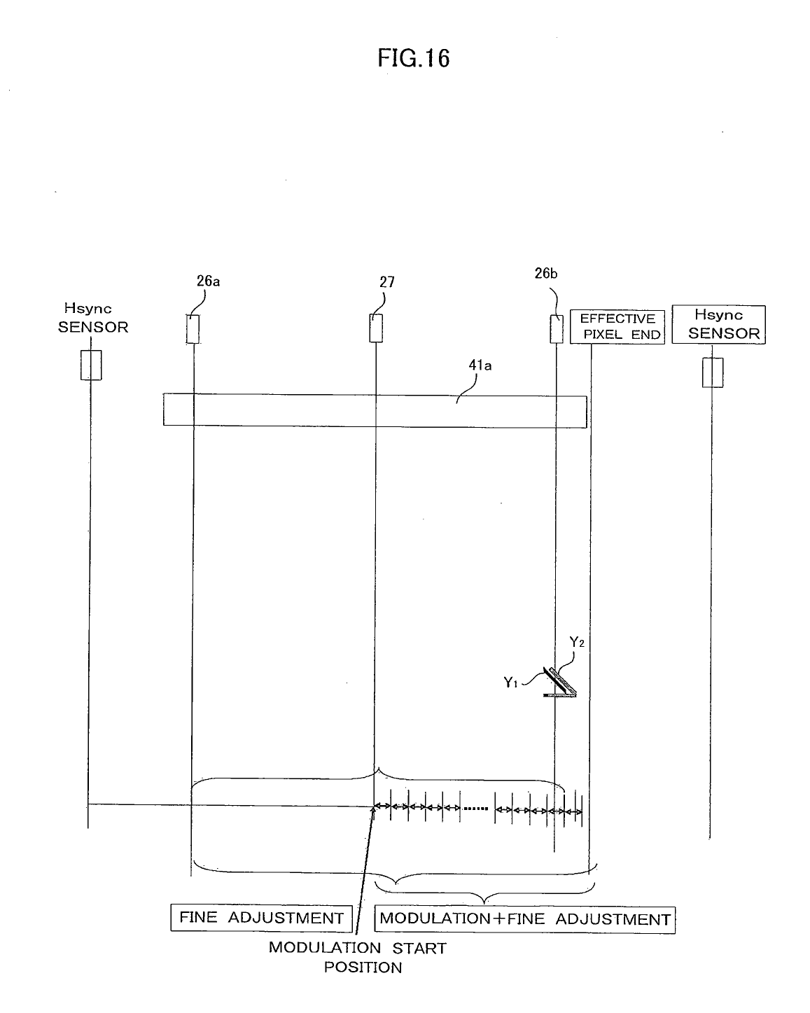

As shown in FIG. 16, toner images (second test images) may be formed to be arranged in the main scanning direction by performing modulation by the respective laser control sections 68. By this, the test patterns can be formed in a shorter time. These toner images are required to be formed within the detection range of the position shift sensor 26. Incidentally, in the illustrated example, the failures of the respective LDs of the LD array 72Y are detected.

### Embodiment 3

In the foregoing embodiments 1 and 2, the failures of the respective LDs included in the LD arrays 72Y to 72K are determined by checking the images transferred to the transfer belt 45. In this embodiment, the failures of the respective LDs are determined based on the light reception results of lights emitted by the respective LDs.

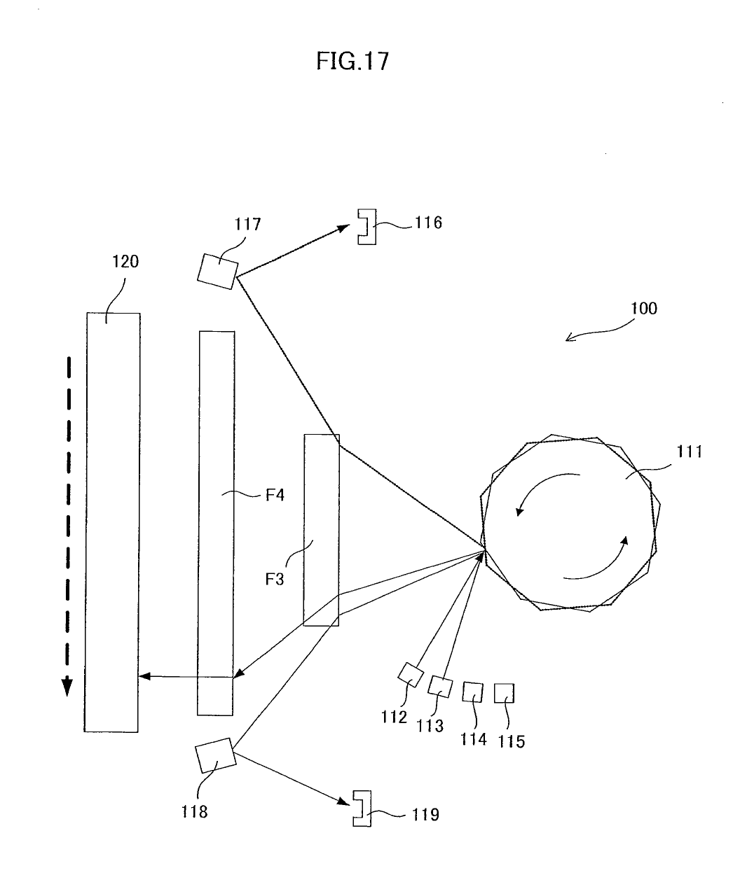

FIG. 17 is a view for explaining scanning of a laser beam in an optical scanning section 110 of this embodiment. FIG. 17 schematically shows a scanning optical path of a laser beam for yellow and that of a laser beam for magenta. Incidentally, the respective photoreceptors corresponding to laser beams for magenta, cyan and black are omitted in the drawing.

With reference to the drawing, in the optical scanning section 110, laser beams emitted from respective laser beam units 112 to 115 are reflected by a polygon mirror 111, and are irradiated to the respective photoconductive drums through fθ lenses F3 and F4 and the like. As described above, the polygon mirror 111 scans the laser beam once in the main scanning direction by the mirror of one surface. By this, an electrostatic latent image is formed on the photoconductive drum 120 by the laser beam scanned in the main scanning direction. Incidentally, each of the laser beam units 112 to 115 includes a 2LD-array type light emitting section including two LDs (light emitting elements).

A BD sensor (first sensor) 116 generates a BD signal each time the sensor detects that a laser beam is scanned once in the main scanning direction. When the polygon mirror 111 is rotated to a position indicated by a dotted line, the laser beam for yellow emitted from the laser beam unit 112 is reflected by the polygon mirror 111, and then is reflected by a reflecting mirror 117 for Y, and is received by the BD sensor 116.

A beam detection sensor (second sensor) 119 detects ON and OFF of the beams emitted from the laser beam units 113 to 115. The polygon mirror 111 is rotated to adjust an angle, so that the beams emitted from the laser beam units 113 to 115 can be received by the beam detection sensor 119 through the fθ lens F3 and a reflecting mirror 118.

Here, the beam detection sensor 119 has only to have detection accuracy to such a degree that ON and OFF of the laser beam units 113 to 115 can be detected. Accordingly, an inexpensive sensor having lower accuracy than the BD sensor 116 can be used. By this, the cost can be reduced.

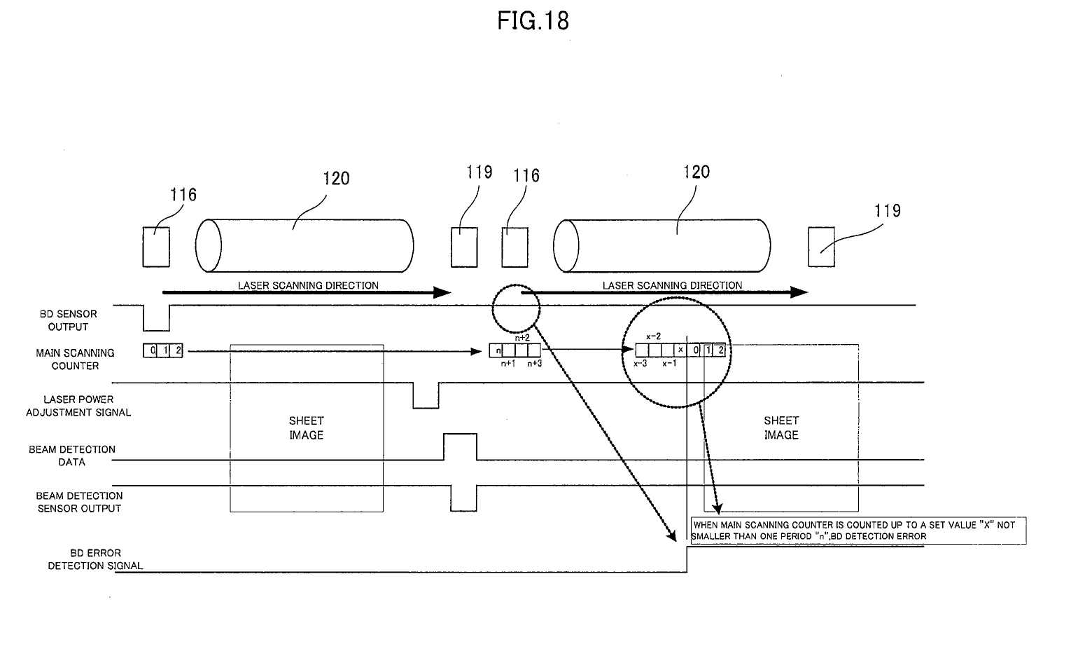

FIG. 18 is a timing chart showing the behavior of various signals when the laser beam unit 112 scans twice in the main scanning direction. In the illustrated example, a BD error signal is outputted due to the failure of the laser beam unit 112.

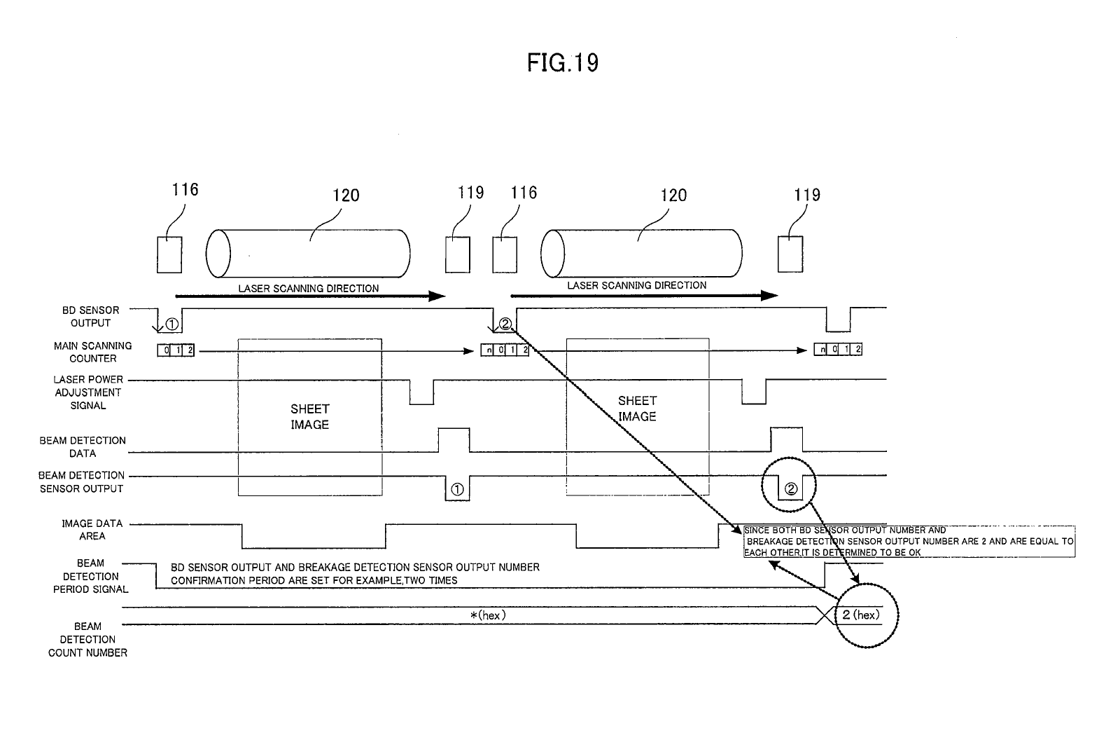

In this embodiment, the failures of the laser beam units 113 to 115 are determined by comparing the number of detection times of light reception of the BD sensor 116 with that of the beam detection sensor 119. FIG. 19 is a timing chart showing an example, and corresponds to the failure detection of the laser beam unit 113. In the illustrated example, both the number of detection times of light reception of the BD sensor 116 and that of the beam detection sensor 119 are two. Accordingly, it is determined that the laser beam unit 113 is not broken.

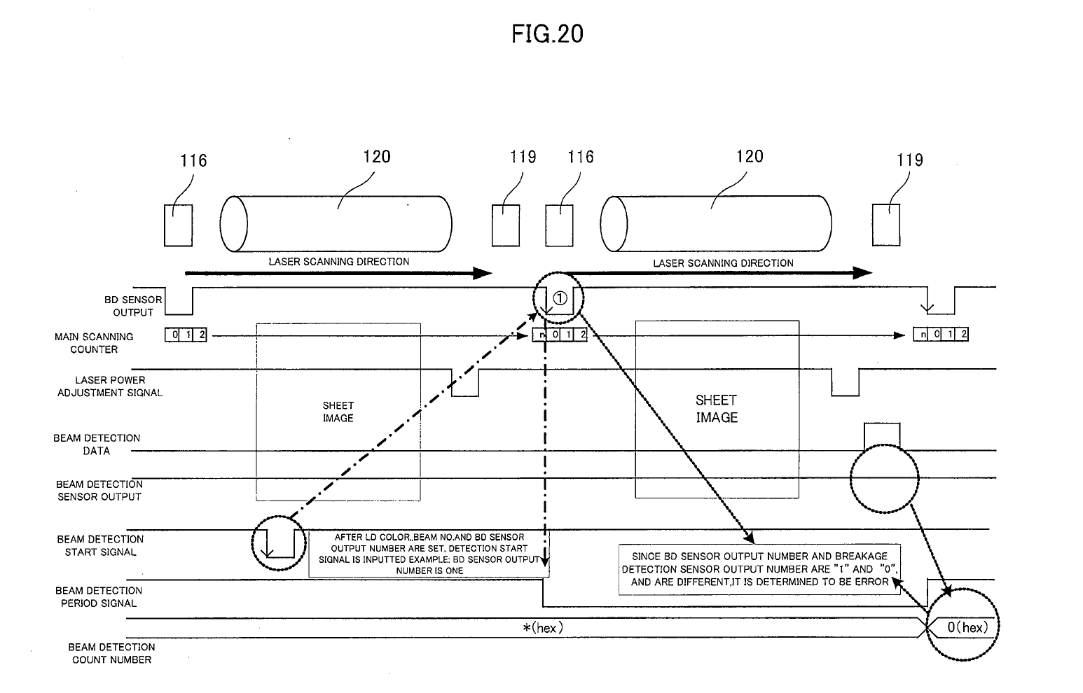

FIG. 20 is a timing chart showing an example of the failure detection, and corresponds to the failure detection of the laser beam unit 113. In the illustrated example, the number of detection times of light reception of the BD sensor 116 is one, and the number of detection times of light reception of the beam detection sensor 119 is 0. Accordingly, it is determined that the laser beam unit 113 is broken.

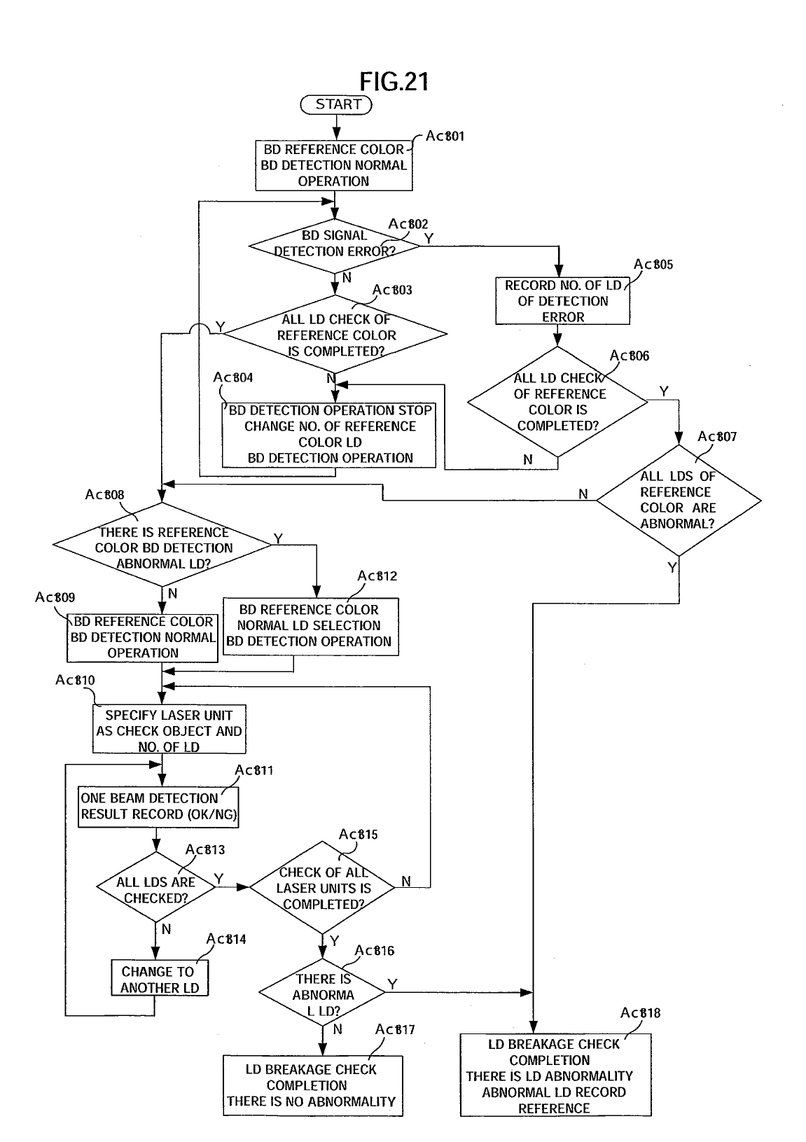

Next, the method of the failure detection of this embodiment will be described in more specifically with reference to FIG. 21. FIG. 21 is a flowchart showing a procedure of failure detection. At Act 301, the LD1 included in the laser beam unit 112 is instructed to emit light. At Act 302, the failure of the LD1 is determined based on the light reception result of the BD sensor 116. When the LD1 is not broken, advance is made to Act 303. At Act 303, it is determined whether the failure detection is performed on all the LDs included in the laser beam unit 112. In this example, since the failure check of the LD2 of the laser beam unit 112 is not performed, advance is made to Act 304.

At Act 304, the failure detection by the BD sensor 116 is stopped, the object of the failure detection is changed from the LD1 of the laser beam unit 112 to the LD2, the failure check of the LD2 is started, and return is made to Act 302.

At Act 302, when it is determined that the LD1 or the LD2 of the laser beam unit 112 is broken, advance is made to Act 305. At Act 305, the LD number of the LD (for example, the LD2) determined to be broken is stored in a not-shown memory.

At Act 306, it is determined whether the failure check of all the LDs included in the laser beam unit 112 is completed. When the failure check of all the LDs is completed, advance is made to Act 307. When the failure check of all the LDs is not completed, advance is made to Act 304.

At act 307, information on the broken LD number is read from the memory, and it is determined whether all the LDs included in the laser beam unit 112 are broken. When at least one LD is not broken, advance is made to Act 308. When all the LDs are broken, advance is made to Act 318.

At act 308, information on the broken LD number is read from the memory, and it is determined whether at least one LD (except for all the LDs) included in the laser beam unit 112 is broken. When at least one LD is broken, advance is made to Act 312. When there is no broken LD, advance is made to Act 309.

At Act 312, the LD not broken in the laser beam unit 112 is selected and is made to emit light, and the detection operation of the BD sensor 116 is performed. That is, the detection operation shown at Act 312 corresponds to “BD sensor output” in the timing chart of FIG. 19.

At Act 310, a laser beam unit as a check object among the laser beam units 113 to 115 and an LD made to emit light are selected. At Act 311, the LD selected at Act 310 is made to emit light, the failure is determined, and the result is stored in a memory. At Act 313, it is determined whether all the LDs of the laser beam unit selected at Act 310 are checked. When all the LDs are not checked, advance is made to Act 314, and another LD is checked. When all the LDs are checked, advance is made to Act 315, and it is determined whether the check of all the laser beam units 113 to 115 is completed.

At Act 315, when all the laser beam units 113 to 115 are not checked, return is made to Act 310, and when all the laser beam units 113 to 115 are checked, advance is made to Act 316. At Act 316, it is determined in the failure check whether there is abnormality in an LD, and when there is no abnormality, advance is made to Act 317, and the failure check is completed. When there is abnormality, advance is made to Act 318, the information relating to the color of the broken laser beam unit and the No. of the LD is read from the memory, and this is notified. Here, printing on a sheet or display on a display can be used as a unit configured to notify the information.

According to this embodiment, the failures of the LDs included in the laser units 112 to 115 can be determined without printing on a sheet.

### Embodiment 4

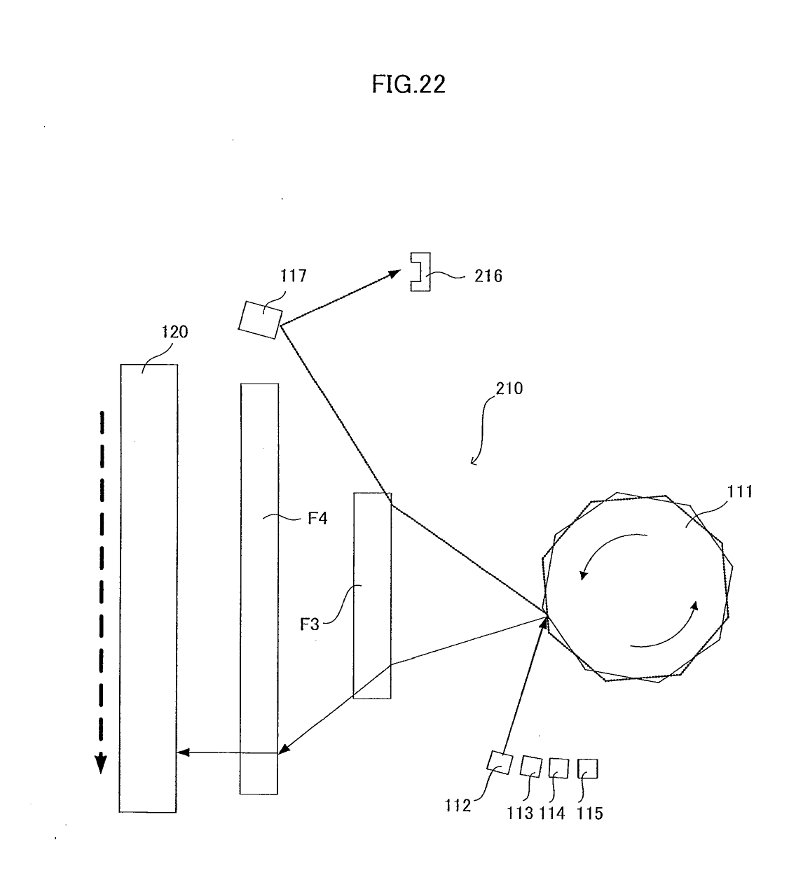

In this embodiment, the failure check of all laser beam units is performed using a BD sensor 216. FIG. 22 is a view for explaining scanning of a laser beam in an optical scanning section 210. FIG. 22 schematically shows a scanning optical path of a laser beam for yellow. The same component as that of the embodiment 3 is denoted by the same reference numeral and its description is omitted.

An emitted light of a laser beam unit 112 is reflected by a polygon mirror 111, and is received by the BD sensor 216 through an Fθ1 lens F3 and a reflecting mirror 117 for Y. Based on the light reception result, a writing position in the main scanning direction is corrected, or failure check of respective LDs included in the laser beam unit 112 is performed.

The emitted light of a laser beam unit 113 is reflected by the polygon mirror 111, and is received by the BD sensor 216 through the Fθ1 lens F3 and a reflecting mirror for M (not shown). Based on the light reception result, failure check of respective LDs included in the laser beam unit 113 is performed.

The emitted light of a laser beam unit 114 is reflected by the polygon mirror 111, and is received by the BD sensor 216 through the Fθ1 lens F3 and a reflecting mirror for C (not shown). Based on the light reception result, failure check of respective LDs included in the laser beam unit 114 is performed.

The emitted light of a laser beam unit 115 is reflected by the polygon mirror 111, and is received by the BD sensor 216 through the Fθ1 lens F3 and a reflecting mirror for K (not shown). Based on the light reception result, failure check of respective LDs included in the laser beam unit 115 is performed.

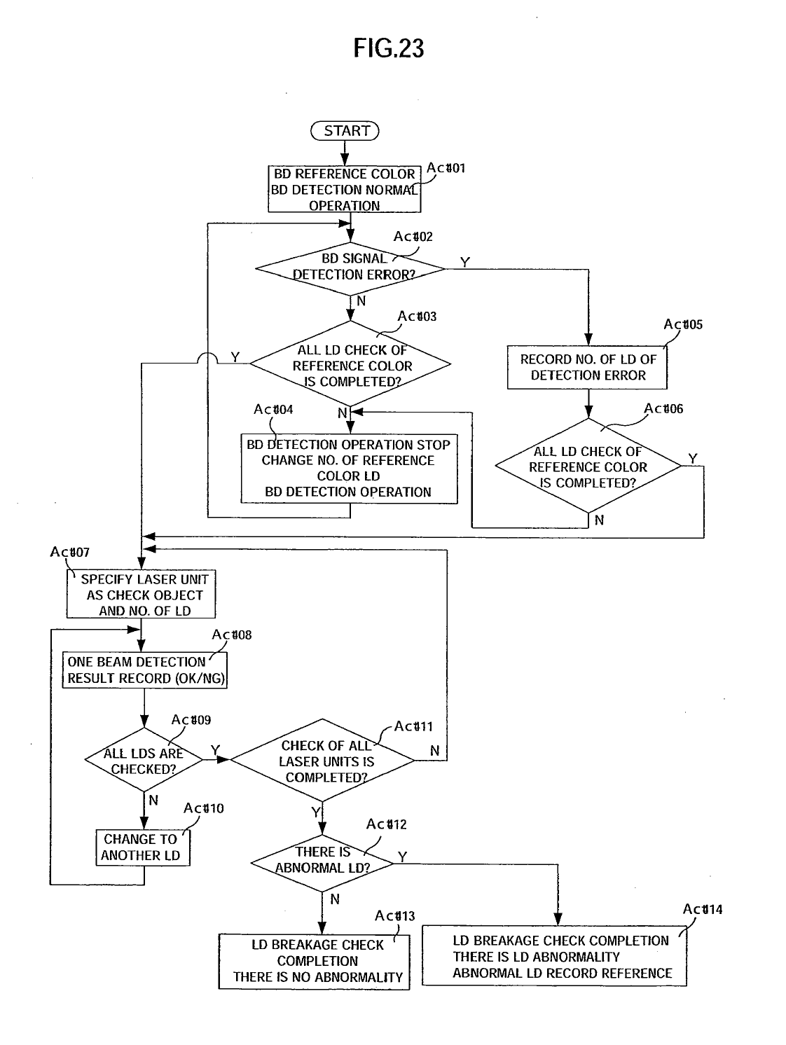

Next, the method of the failure check will be more specifically described with reference to FIG. 23. FIG. 23 is a flowchart showing a procedure of the failure check. At Act 401, the LD1 included in the laser beam unit 112 is instructed to emit light. At Act 402, the failure of the LD1 is determined based on the light reception result of the BD sensor 216. When the LD1 is not broken, advance is made to Act 403. At Act 403, it is determined whether the failure check is performed on all the LDs included in the laser beam unit 112. In this example, since the failure check of the LD2 of the laser beam unit 112 is not performed, advance is made to Act 404.

At Act 404, the failure detection of the BD sensor 216 is stopped, the object of the failure detection is changed from the LD1 of the laser beam unit 112 to the LD2, the failure check of the LD2 is started, and return is made to Act 402.

At Act 402, when it is determined that the LD1 or the LD2 of the laser beam unit 112 is broken, advance is made to Act 405. At Act 405, the LD number of the LD (for example, the LD2) determined to be broken is stored in a not-shown memory.

At Act 406, it is determined whether the failure check is performed on all LDs included in the laser beam unit 112. When the failure check is performed on all the LDs, advance is made to Act 407, and when the failure check is not completed on all the LDs, return is made to Act 404.

At Act 407, among the laser beam units 113 to 115, a laser beam unit as a check object and an LD to be made to emit light are selected. At Act 408, the LD selected at Act 407 is made to emit light, the failure is determined, and the result is stored in a memory. At Act 409, it is determined whether the failure check is completed on all the LDs of the laser beam unit selected at Act 407. When all the LDs are not checked, advance is made to Act 410, and another LD is checked. When all the LDs are checked, advance is made to Act 411, and it is determined whether the check is completed on all the laser beam units 113 to 115.

At Act 411, when all the laser beam units 113 to 115 are not checked, return is made to Act 407, and when all the laser beam units 113 to 115 are checked, advance is made to Act 412. At Act 412, it is determined in all the failure checks whether there is abnormality in an LD, and when there is no abnormality, advance is made to Act 413, and the failure check is completed. When there is abnormality, advance is made to ACT 414, information relating to the color of the broken laser beam unit and the No. of the LD is read from the memory, and this is notified. Here, printing on a sheet or display on a display can be used as a unit configured to notify the information.

According to this embodiment, the failure detection of all the laser beam units 112 to 115 can be performed by using the BD sensor 216 used for reference position signal output in the main scanning direction. Accordingly, since the beam detection sensor 119 of the embodiment 3 can be omitted, the cost can be reduced. Besides, the failures of the respective LDs included in the laser beam units 112 to 115 can be determined without printing on a sheet.

### Embodiment 5

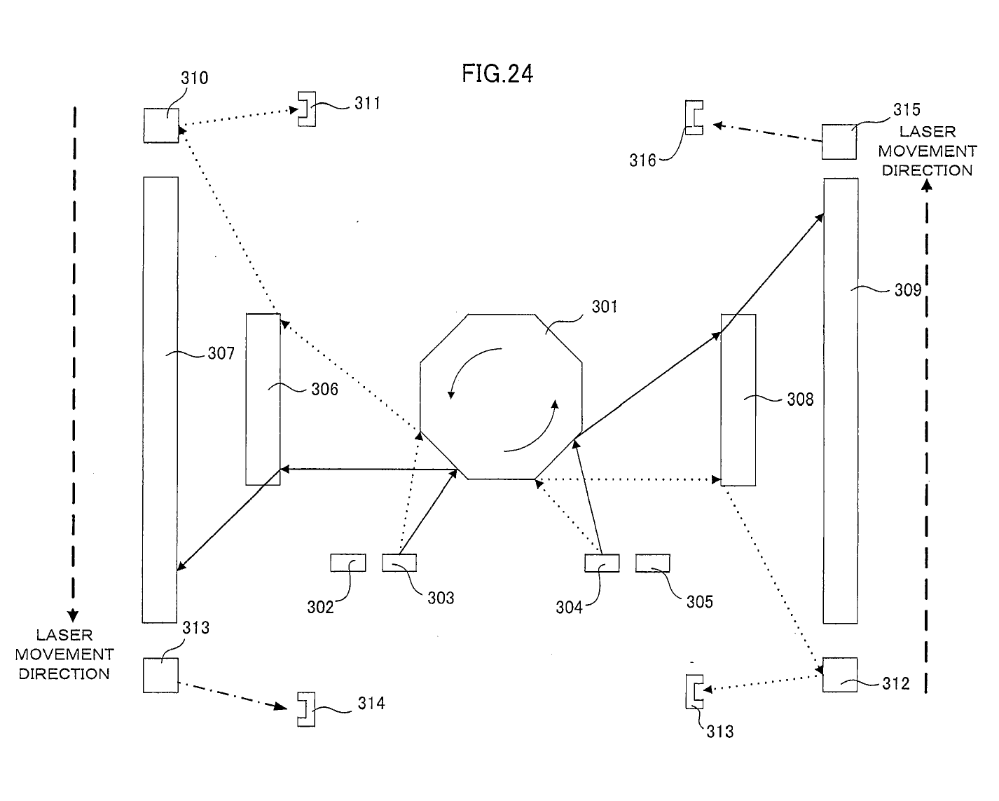

FIG. 24 is a view for explaining scanning of a laser beam in an optical scanning section of embodiment 5. With reference to the drawing, the emitted light of a laser beam unit 302 for Y is received by a BD sensor 311 for Y through a polygon mirror 301, a front side Fθ1 lens 306 and a mirror 310. The failures of the respective LDs included in the laser beam unit 302 are determined based on this light reception result.

The emitted light of a laser beam unit 303 for M is received by a beam detection BD sensor 314 for M through the polygon mirror 301, the front side Fθ1 lens 306 and a mirror 313. The failures of the respective LDs included in the laser beam unit 303 are determined based on this light reception result.

The emitted light of a laser beam unit 304 for C is received by a beam detection sensor 316 for C through the polygon mirror 301, a rear side Fθ1 lens 308 and a mirror 315. The failures of the respective LDs included in the laser beam unit 304 are determined based on this light reception result.

The emitted light of a laser beam unit 305 for K is received by a BD sensor 313 for K through the polygon mirror 301, the rear side Fθ1 lens 308 and a mirror 312. The failures of the respective LDs included in the laser beam unit 305 are determined based on this light reception result.

That is, in this embodiment, the failure check of the respective laser beam units 302 to 305 is performed using the separate sensors.

### Embodiment 6

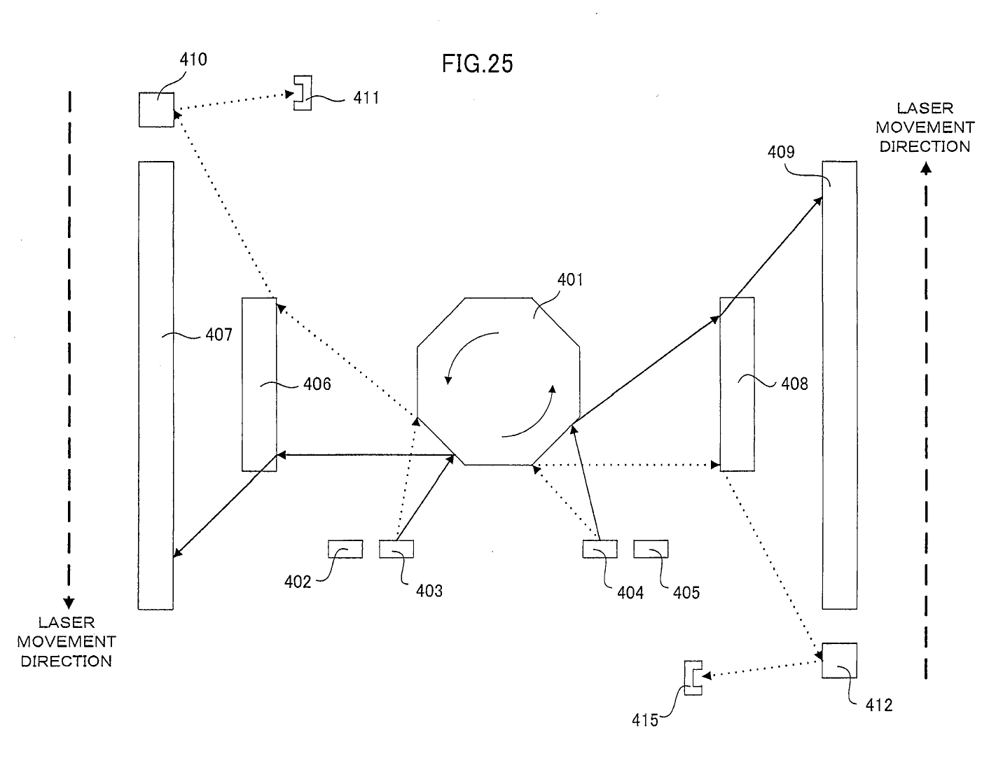

FIG. 25 is a view for explaining scanning of a laser beam in an optical scanning section of embodiment 6. With reference to the drawing, the emitted light of a laser beam unit 402 for Y is received by a BD sensor 411 for Y and M through a polygon mirror 401, a front side Fθ1 lens 406 and a mirror 410. The failures of the respective LDs included in the laser beam unit 402 are determined based on this light reception result.

The emitted light of a laser beam unit 403 for M is received by the BD sensor 411 for Y and M through the polygon mirror 401, the front side Fθ1 lens 406 and a mirror (not shown). The failures of the respective LDs included in the laser beam unit 403 are determined based on this light reception result.

The emitted light of a laser beam unit 404 for C is received by a BD sensor 413 for K and C through the polygon mirror 401, a rear side Fθ1 lens 408 and a mirror 412. The failures of the respective LDs included in the laser beam unit 404 are determined based on this light reception result.

The emitted light of a laser beam unit 405 for K is received by the BD sensor 413 for K and C through the polygon mirror 401, the rear side Fθ1 lens 408 and a mirror (not shown). The failures of the respective LDs included in the laser beam unit 405 are determined based on this light reception result.

That is, the failure check of the laser beam units 402 403 is performed by using the one BD sensor 411, and the failure check of the laser beam units 404 and 405 is performed by using the one BD sensor 413.

The present invention can be carried out in various forms without departing from the spirit or the principal feature. Thus, the foregoing embodiments are merely exemplary in all points and should not be restrictedly interpreted. The scope of the invention is defined by the claims and is not restricted by the text of the specification. Further, all modifications, various improvements, substitutions and alterations within the equivalent range of the claims are within the scope of the invention.

As described above in detail, according to the invention, it is possible to provide an image forming apparatus in which the failure of a light emitting element of each light emitting section can be detected without printing on a sheet.

What is claimed is:

1. An image forming apparatus comprising:
an optical scanning section including a plurality of light emitting sections each including a plurality of light emitting elements;
a plurality of photoreceptors which are provided correspondingly to the respective light emitting sections and on which electrostatic latent images are formed by emitted lights of the respective light emitting sections;
developing sections to develop the respective electrostatic latent images formed on the respective photoreceptors with toners of different colors;
a transfer target section to which respective images developed by the developing sections are transferred;
a density detection section to detect densities of the respective images transferred to the transfer target section; and
a failure determination section, wherein when registration control is performed based on respective first test images transferred from the respective photoreceptors, the density detection section detects a density of a second test image formed on the transfer target section by causing a light emitting element included in a first light emitting section among the plurality of light emitting sections to emit light, and the failure determination section determines a failure of the light emitting element based on a detection result.

2. The apparatus of claim 1, wherein the failure determination section determines that the first light emitting section is broken when the density of the second test image detected by the density detection section is lower than a density threshold set according to a color of toner corresponding to the first light emitting section.

3. The apparatus of claim 1, wherein a plurality of the second test images are arranged in a sub-scanning direction.

4. The apparatus of claim 1, wherein
the transfer target section is a primary transfer belt rotating endlessly,
the first test images are formed at both ends of the primary transfer belt in a rotation axis direction, and
the second test image is formed at a center of the primary transfer belt in the rotation axis direction.

5. The apparatus of claim 1, wherein the registration control includes at least a correction process to correct a writing position in a main scanning direction.

6. An image forming apparatus comprising:
an optical scanning section including a plurality of light emitting sections each including a plurality of light emitting elements;
a plurality of photoreceptors which are provided correspondingly to the respective light emitting sections and on which electrostatic latent images are formed by emitted lights of the respective light emitting sections;
developing sections to develop the respective electrostatic latent images formed on the respective photoreceptors with toners of different colors;
a transfer target section to which respective images developed by the developing sections are transferred;
a registration detection section to acquire information for registration control from the respective images transferred to the transfer target section; and
a failure determination section, wherein when image quality maintenance control is performed based on respective first test images transferred from the respective photoreceptors, the registration detection section detects a second test image formed on the transfer target section by causing a light emitting element of a first light emitting section among the plurality of light emitting sections to emit light, and the failure determination section determines a failure of the light emitting element based on a detection result.

7. The apparatus of claim 6, wherein the failure determination section determines that the light emitting element is broken when the detection information acquired by the registration detection section is lower than a threshold.

8. The apparatus of claim 6, wherein a plurality of the second test images are arranged in a sub-scanning direction.

9. The apparatus of claim 6, wherein a plurality of the second test images are arranged in a main scanning direction in a detectable region of the registration detection section.

10. The apparatus of claim 6, wherein
the transfer target section is a primary transfer belt rotating endlessly,
the first test images are formed at a center of the primary transfer belt in a rotation axis direction, and
the second test image is formed at both ends of the primary transfer belt in the rotation axis direction.

11. An image forming apparatus comprising:
an optical scanning section including a plurality of light emitting sections each including a plurality of light emitting elements;
a first sensor to acquire correction information for correcting a writing position in a main scanning direction by receiving an emitted light from a first light emitting section among the plurality of light emitting sections;
a second sensor which receives an emitted light from a second light emitting section different from the first light emitting section among the plurality of light emitting sections and has a detection accuracy lower than that of the first sensor; and
a failure determination section which determines a failure of the first light emitting section based on presence or absence of light reception in the first sensor when the respective light emitting elements included in the first light emitting section are made to emit light, and determines a failure of the second light emitting section based on presence or absence of light reception in the second sensor when the respective light emitting elements included in the second light emitting section are made to emit light.

12. The apparatus of claim 11, wherein
the plurality of light emitting sections include a third light emitting section different from the first and the second light emitting sections,
the second sensor receives an emitted light from the third light emitting section, and
the failure determination section determines a failure of the third light emitting section based on presence or absence of light reception in the second sensor when the respective light emitting elements included in the third light emitting section are made to emit light.

13. The apparatus of claim 11, wherein
the optical scanning section includes a polygon mirror and an fθ lens to correct an optical characteristic of a light reflected by the polygon mirror,
the fθ lens has a first area positioned in an optical path of the light which is reflected by the polygon mirror and forms an image on a photoreceptor, and
the second sensor receives a light passing through a second area different from the first area in the fθ lens.

14. The apparatus of claim 13, further comprising a reflecting mirror to reflect the light passing through the second area to the second sensor.

15. An image forming apparatus comprising:
an optical scanning section including a plurality of light emitting sections each including a plurality of light emitting elements;
a sensor to optically acquire correction information for correcting a writing position in a main scanning direction; and
a failure determination section to determine failures of the respective light emitting sections based on presence or absence of light reception in the sensor when the respective light emitting elements included in the respective light emitting sections are made to emit light.

16. The apparatus of claim 15, wherein
the optical scanning section includes a polygon mirror and an fθ lens to correct an optical characteristic of a light reflected by the polygon mirror,
the fθ lens has a first area positioned in an optical path of the light which is reflected by the polygon mirror and forms an image on a photoreceptor, and
the sensor receives a light passing through a second area different from the first area in the fθ lens.

17. The apparatus of claim 16, further comprising a plurality of reflecting mirrors which are provided correspondingly to the respective light emitting sections and reflect the light passing through the second area to the sensor.
